(19) United States
(12) Patent Application Publication
(10) Pub. No.: US 2009/0244693 A1
(43) Pub. Date: Oct. 1, 2009

(54) POLYMER GEL-CONTAINING COMPOSITION, LIGHT MODULATING DEVICE AND LIGHT MODULATING METHOD

(75) Inventors: Ryo NISHIO, Kanagawa (JP); Naoyuki HAYASHI, Kanagawa (JP); Takashi KATO, Kanagawa (JP); Ryojiro AKASHI, Kanagawa (JP)

Correspondence Address: Moss & Burke, PLLC, 401 Holland Lane, Suite 407, Alexandria, VA, 22314, US

(73) Assignee: FUJIFILM CORPORATION, Tokyo (JP)

(21) Appl. No.: 12/406,121

(22) Filed: Mar. 18, 2009

(30) Foreign Application Priority Data
Mar. 31, 2008 (JP) 2008-093892

(51) Int. Cl. G02F 1/00; C09K 9/02

(52) U.S. Cl. 359/321; 252/583

(57) ABSTRACT

The polymer gel-containing composition of the present invention contains a solvent having a dielectric constant ε of 5 or less at 20° C., and an ionic polymer gel whose volume is changeable due to being driven with voltage. The ionic polymer gel preferably has a hydrophobic group and an ionic group, and the ionic group preferably has delocalized charge. Further, the ionic polymer gel preferably has a hydrophilic group.

### CROSS REFERENCE TO RELATED APPLICATIONS

This application claims priority under 35USC 119 from Japanese Patent Application No. 2008-093892, the disclosure of which is incorporated herein by reference.

### BACKGROUND OF THE INVENTION

1. Field of the Invention

The present invention relates to a polymer gel-containing composition, a light modulating device, and a light modulating method.

2. Description of the Related Art

It has been known that a polymer gel undergoes volumetric phase transition by an electric field. Gel particles, in which pigment is dispersed, change the light scattering rate, the optical reflectance or the light absorbance with the change in volume by applying an electric field. Light modulation and display can be made with the use of this phenomenon.

In an optical element using such a polymer gel, a technology, in which pigment in polymer gel particles is set to a specific concentration, is proposed in order to realize a high contrast and quick responsiveness (for example, refer to Japanese Patent No. 354364).

The change in volume of the polymer gel takes place in a solvent, and the volume of the polymer gel varies with the absorption and release of the solvent. In order to cause such a volume change, a highly polar solvent has been used in conventional polymer gel optical elements. However, there have been problems such that an electrode is corroded due to electrolysis attributed to an electric current-flow in such a highly polar solvent, or the display performance or light modulating property is impaired due to the generation of bubbles.

Further, since the boiling point of the conventional solvent is low, the solvent is apt to be wasted away due to volatilization, and is thermally and electrically unstable. When an electroconductive solvent other than water is used, there is a concern such that an increase in environmental load due to the vaporization or leakage of the solvent may arise. Furthermore, there has been a problem such that wasteful electric power consumption attributed to the electrical energization of the solvent occurs, resulting in reduction of the effective voltage.

Under these general circumstances, despite a high demand for increasing the size of a display or a light modulating element, the fulfillment of such a demand has been difficult.

Accordingly, in order to solve such a problem, a technology for using a chargeable polymer gel has been proposed in Japanese Patent Application Laid-Open (JP-A) No. 2003-147221. In this technology, an electrical insulating liquid is combined with a chargeable polymer gel, so that an electric current-flow through the polymer gel is prevented.

However, with this technology, since dimethyl formamide (DMF) is used as a solvent, an electric current flow cannot be prevented completely.

Moreover, in JP-A No. 2005-200577, a technology of isolating a domain containing a polymer gel by a holding member is proposed. In this optical element, an electrical insulating liquid is used as a solvent, and it is expected that a decomposition reaction attributable to an electrode reaction can be prevented.

However, in this technology, a part of the solvent is replaced with dimethyl formamide (DMF) or the like, and the solvent as a whole is a solvent through which an electric current flows.

### SUMMARY OF THE INVENTION

According to a first aspect of the present invention, there is provided a polymer gel-containing composition comprising a solvent having a dielectric constant of 5 or less at 20° C., and an ionic polymer gel whose volume is changeable due to being driven with voltage.

According to a second aspect of the present invention, there is provided a light modulating device comprising: a pair of electrodes, at least one of which is a transparent electrode; and a layer containing the polymer gel-containing composition according to claim 1 between the electrodes.

According to a third aspect of the present invention, there is provided a light modulating method using a light modulating device comprising a pair of electrodes, at least one of which is a transparent electrode, and a layer containing the polymer gel-containing composition according to claim 1 between the electrodes, the method comprising applying a voltage to the light modulating device by changing the polarity of the pair of the electrodes alternately.

### BRIEF DESCRIPTION OF THE DRAWING

FIG. 1A is a drawing illustrating a state where an ionic polymer gel is swollen;

FIG. 1B is a drawing illustrating a state where an ionic polymer gel is contracted;

FIG. 2A is a drawing illustrating a state where light is incident on an ionic polymer gel particle in a swollen state;

FIG. 2B is a drawing illustrating a state where light is incident on an ionic polymer gel particle in a contracted state; and

FIG. 3 is a schematic configurational drawing illustrating an example of an optical element (for example, a light modulating device) according to the present invention.

### DETAILED DESCRIPTION OF THE INVENTION

As mentioned above, in the conventional technology, solvent carries electric current due to a high polarity of the solvent, so that it was difficult to prevent corrosion of the electrode, deterioration of display quality or light modulating property over time.

As a result of enthusiastic study by the inventors, it has been found that displaying or light modulation can be carried out without flowing an electric current in a solvent in the case where an ionic polymer gel capable of being swollen by being driven with voltage is used, and on the basis of the findings, it has been found a polymer gel-containing composition which can stably repeat swelling and contracting while preventing an electrode from being corroded, and a polymer gel preferable for the polymer gel-containing composition. Furthermore, a light modulating device and light modulating method using the polymer gel-containing composition have been devised.

According to the present invention, there are provided a polymer gel-containing composition which can stably repeat swelling and contracting while preventing an electrode from being corroded, a light modulating device and a light modulating method.

Hereinafter, the present invention will be described in detail. The denotation “to” in this specification means the numerals before and after “to”, both inclusive as the minimum value and the maximum value, respectively.

<Polymer Gel-Containing Composition>

The polymer gel-containing composition of the present invention contains at least (1) a solvent having a dielectric constant ε of 5 or less at 20° C. (hereinafter, may be referred to as a “hydrophobic solvent”), and (2) an ionic gel whose volume is changeable due to being driven with voltage. Further, pigment or the like may be preferably added to the composition.

Here, in the present invention, the “polymer gel” is referred to as a polymer compound capable of involving a solvent therein. Both the state where a solvent is involved in the polymer compound, and the state where a solvent is released from the polymer compound and is not involved in the polymer compound, are included within the scope of “polymer gel”.

In the present invention, the term “being driven with voltage” means the state where display or light modulation driving is carried out by swelling or contracting a polymer gel, in a state where electric current is not detectable. More specifically, the display or light modulation driving is carried out in a state where electric current does not flow, or in a state where only an electric current of 1 μA/cm² or less flows, even if electric current flows.

In the present invention, a solvent having a dielectric constant ε of 5 or less at 20° C. is used as a solvent. In such a solvent with a low dielectric constant, even if a voltage is applied to an electrode, electric current does not flow or only very small electric current such as 1 μA/cm² or less electric current flows. Accordingly, the polymer gel-containing composition using the hydrophobic solvent according to the present invention does not cause a decomposition reaction of a solvent attributed to an electrode reaction, but the polymer gel can be repeatedly swollen and contracted stably. Further, power consumption can be reduced when the composition is applied to an optical element.

Hereinafter, the polymer gel-containing composition is explained in detail for each constituent component.

(1) Solvent

The polymer gel-containing composition of the present invention contains a hydrophobic solvent. The hydrophobic solvent in the present invention refers to a solvent having a dielectric constant ε of 5 or less at 20° C. Such solvents include, for example, ISOPAR M (registered trademark) manufactured by Exxon Mobil Corporation (dielectric constant 1.9), hexane (dielectric constant 1.9), toluene (dielectric constant 2.2), chloroform (dielectric constant 4.7), pentane (dielectric constant 1.8), heptane (dielectric constant 1.9), octane (dielectric constant 1.9), cyclohexane (dielectric constant 2.1), dioxane (dielectric constant 2.2), carbon tetrachloride (dielectric constant 2.2), o-xylene (dielectric constant 2.3), p-xylene (dielectric constant 2.3), m-xylene (dielectric constant 2.4), benzene (dielectric constant 2.3), carbon disulfide (dielectric constant 2.6), trichloroethylene (dielectric constant 3.4), diethyl ether (dielectric constant 4.2), a mineral oil (dielectric constant 1.9 to 2.5), gas oil (dielectric constant 1.9), a paraffin oil (dielectric constant 4.5 to 4.9).

The solvent according to the present invention has an extremely low dielectric constant as compared with solvents conventionally used. More specifically, dimethyl formamide (DMF) has a dielectric constant of 37, dimethyl sulfoxide (DMSO) has a dielectric constant of 47 and propylene carbonate (PC) has a dielectric constant of 69, and water has a dielectric constant of 80, which are conventionally used. Thus, the dielectric constant of the hydrophobic solvents of the present invention is roughly one-tenth of those of the conventional solvents.

The solvents in the present invention may be a mixture of two or more kinds of solvents. However, even after mixing solvents, the dielectric constant ε at 20° C. of the mixture of the solvents must be 5 or less. It is possible to use solvents other than the above together as long as the dielectric constant of the mixed solvents is in the above range.

Further, it is preferable that the difference between the refractive index of the hydrophobic solvent and the refractive index of an ionic polymer gel (including a colorant therein), which will be described later, is 0.01 or less. When a solvent having a small difference of the refractive index is used, the light-scattering at the interface of particles decreases, so that the color purity can be improved. By combining a hydrophobic solvent with an ionic polymer gel, in which the difference between the refractive index of the hydrophobic solvent and the refractive index of the ionic polymer gel is small, when colored ionic polymer gel particles are used, incident light on the polymer gel particles transmits therethrough without scattering even at the time of color formation, so that the polymer gel particles can be used for a light-transmission type optical element.

(2) Ionic Polymer Gel

The polymer gel-containing composition of the present invention contains an ionic polymer gel whose volume is changeable due to being driven with voltage in the hydrophobic solvent.

The conventional polymer gels swell and contract in a polar solvent. In general, since a salt is ionically dissociated and dissolved in a polar solvent, a polymer gel having a salt structure tends to be dissolved due to the ionic dissociation of the salt structure thereof in a polar solvent. However, since a polymer gel has a network structure cross-linked at cross-linking positions, the polymer gel does not dissolve in a solvent and maintains the shape thereof, and as a result, the polymer gel swells. Namely, it has been generally considered that a polymer gel swells and contracts only in a polar solvent.

In contrast, in the present invention, it has been found that an ionic polymer gel can swell and contract even in a hydrophobic solvent.

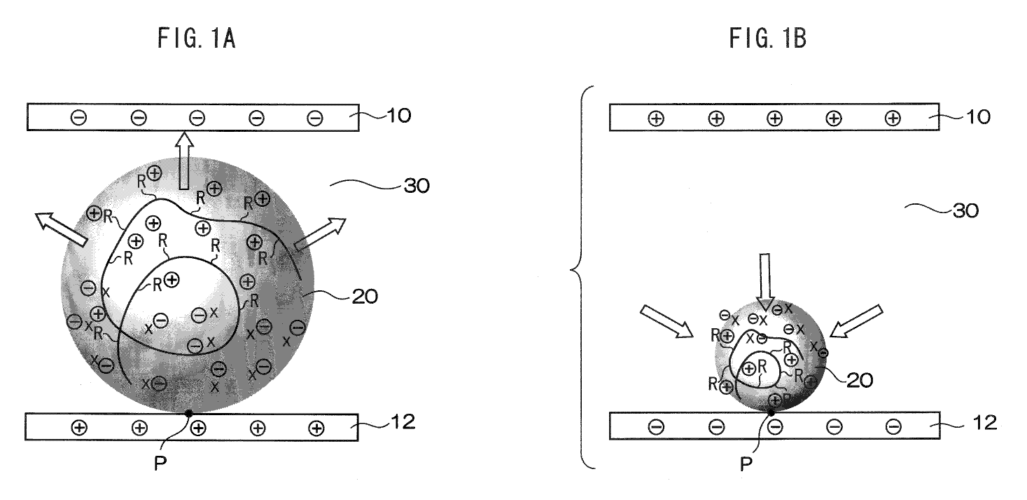

The principle of the electric field responsiveness of an ionic polymer gel of the present invention is explained with reference to FIGS. 1A and 1B. However, this principle is a presumption and the present invention shall not be construed in a limited way.

FIG. 1A is a drawing explaining a state where an ionic polymer gel is swollen, and FIG. 1B is a drawing explaining a state where the ionic polymer gel is contracted.

An optical element of FIGS. 1A and 1B has a first electrode 10 and a second electrode 12 opposite each other, and a polymer gel-containing composition containing a hydrophobic solvent 30 and an ionic polymer gel 20 is injected between the electrodes. Here, the ionic polymer gel 20 shown in FIGS. 1A and 1B is a cationic polymer gel.

In the optical element (including a light modulating device) of the present invention, the polymer gel 20 is preferably fixed to either of the electrode 10 or the electrode and 12 so that the ionic polymer gel 20 is swollen and contracted reversibly by the interaction between the polymer gel and the electrode 10 or 12. Details of the fixation will be described later. In FIGS. 1A and 1B, the polymer gel 20 is fixed to the second electrode 12 at the fixing point P.

At least a part of the ionic groups in the ionic polymer gel 20 of the present invention is ionically dissociated in the hydrophobic solvent 30.

In the optical element of FIG. 1A, when voltage is applied to the first electrode 10 as a cathode and to the second electrode 12 as an anode, dissociated cations in the polymer gel having the cations as ionic groups are attracted to the first electrode 10 side as the cathode, thereby increasing the volume of the polymer gel. In this way, the hydrophobic solvent 30 penetrates into the polymer gel 20 where the polymer gel 20 has become sparse, and the penetration of the hydrophobic solvent 30 is further facilitated by an electro-osmosis effect. As a result, the volume of the ionic polymer gel 20 increases.

Next, as shown in FIG. 1B, the polarity of the electrodes is reversed. When a voltage is applied to the first electrode 10 as an anode and to the second electrode 12 as a cathode, the positive charge of the first electrode 10 and the cations of the polymer gel 20 repel each other, while the cations of the polymer gel 20 are attracted to the negative charge of the second electrode 12, so that the volume of the polymer gel 20 is contracted. Thus, the polymer gel 20 swells and contracts by reversing the polarity of the electrodes.

In addition, although the principle of the electric field response is explained using the cationic polymer gel in FIGS. 1(a) and 1(b), an anionic polymer gel also responds to the electric field. That is, as shown in FIGS. 1(a) and 1(b), when the cationic polymer gel is used, the polymer gel is swollen by applying a voltage to the electrode, to which the polymer gel is fixed, as an anode, and when the electrodes are reversed, the polymer gel is contracted. On the other hand, when the anionic polymer gel is used, the polymer gel is contracted in the case where an electrode to which the polymer gel is fixed is made to be an anode, and when the electrodes are reversed, and the electrode, to which the polymer gel is fixed, is made to be a cathode, the polymer gel is swollen.

Thus, the ionic polymer gel of the present invention may be anionic, or may be cationic.

In order to facilitate the electric field responsiveness, or increase a swelling ratio of the ionic polymer gel, it is preferable to design so as to promote the ionic dissociation of the ionic polymer gel in a hydrophobic solvent. Such an ionic polymer gel contains preferably hydrophobic portions so as to increase the affinity of the ionic polymer for the hydrophobic solvent. In addition, the ionic polymer gel contains preferably ionic groups to be ionically dissociated. That is, it is preferable that the ionic polymer gel of the present invention contains at least hydrophobic groups for an increase in the affinity for a hydrophobic solvent, and ionic groups for ionic dissociation.

The hydrophobic groups of the ionic polymer gel of the present invention include, preferably a straight-chained, branched or cyclic alkyl group having 6 to 50 carbon atoms, or an aromatic group having 5 to 50 carbon atoms (for example, a monocyclic aromatic group or a condensed polycyclic aromatic group, which is formed of a carbon atom, a hydrogen atom, a nitrogen atom, an oxygen atom or a sulfur atom, or a combination of a plurality of these aromatic groups); more preferably a straight-chained, branched or cyclic alkyl group having 6 to 50 carbon atoms, or an aromatic group formed of only 5 to 50 carbon atoms and hydrogen atoms; further more preferably a straight-chained, branched or cyclic alkyl group having 10 to 36 carbon atoms; and particularly preferably a straight-chained or branched alkyl group having 12 to 18 carbon atoms.

The aromatic group as the hydrophobic group may have one or plural substituents to such an extent that the substituents do not inhibit the hydrophobicity. In this case, as the kind of the substituents, an alkyl group having 1 to 50 carbon atoms, an substituted alkyl group having 1 to 50 carbon atoms, in which one or plural hydrogen atoms are substituted with halogen atoms, a halogen atom, a dialkyl amino group, a monoalkyl amino group, a nitro group, a cyano group or an alkyl ether group having 1 to 50 carbon atoms is preferable; and an alkyl group having 1 to 22 carbon atoms, an substituted alkyl group having 1 to 22 carbon atoms, in which one or plural hydrogen atoms are substituted with halogen atoms, a halogen atom, or an alkyl ether group having 1 to 22 carbon atoms is more preferable; and an alkyl group having 1 to 18 carbon atoms, a trifluoromethyl group, a fluorine atom, a chlorine atom, or an alkyl ether group having 1 to 18 carbon atoms is particularly preferable.

The alkyl group as the hydrophobic group may be any of straight-chained, branched and cyclic alkyl groups, and a straight-chained alkyl group is preferable from the viewpoint of the ease of gelation and the degree of swelling property. The alkyl group as a hydrophobic group may have a substituent, but an alkyl group which does not have a substituent is preferable in view of the degree of the affinity (hydrophobic interaction) for a hydrophobic solvent.

Moreover, the ionic polymer gel in the present invention has an ionic moiety. The ionic moiety is ionically dissociated, and a difference in osmotic pressures is generated, thereby enhancing the swelling property. The ionic moiety may be any of an anionic moiety and a cationic moiety.

In particular, in the present invention, the ionic polymer gel is a polymer gel in which the electric charge in an ionic group is delocalized to promote an ionic dissociation in a non-polar solvent. It is presumed that when the charge in the ionic group is delocalized, the charge is broadly distributed in the proximity of the ionic group, so that an electrostatic interaction between the positive charge and the negative charge is lowered, and the ionic dissociation is promoted. In the present invention, “the charge is delocalized” means that the positive charge or negative electric charge does not exist on a single atom, but the charge is widely distributed over two or more atoms due to the resonance effect.

As such an ionic group, in the case of a cation, a quaternary ammonium ion, a heterocyclic cation and a phosphonium ion are preferable, a quaternary ammonium ion, an aromatic heterocyclic cation and a phosphonium ion are more preferable, and a quaternary ammonium ion and an aromatic heterocyclic cation are still more preferable.

The quaternary ammonium ion has preferably an alkyl group or an aryl group, more preferably a straight-chained, branched, or cyclic alkyl group having 6 to 36 carbon atoms, from the viewpoint of improving the affinity for a solvent while the ionic dissociation being promoted, still more preferably a straight-chained or branched alkyl group having 8 to 22 carbon atoms, and further more preferably a straight-chained alkyl group having 10 to 18 carbon atoms.

The alkyl group of the quaternary ammonium ion may be any of a straight-chained, branched and cyclic alkyl group, and a straight-chained or branched alkyl group is preferable, and straight-chained alkyl group is more preferable from the viewpoint of the degree of the affinity (hydrophobic interaction) for a hydrophobic solvent.

More specifically, as the quaternary ammonium ion having an alkyl group, for example, tri-n-dodecyl ammonium ion, tristearyl ammonium ion, tri-n-docosanyl ammonium ion, distearyl ethyl ammonium ion, and the like may be exemplified, but the quaternary ammonium ions are not limited thereto.

Examples of the heterocyclic cations include, for example, a pyrrolium ion, a pyrazolium ion, a pyrrolidinium ion, an imidazolium ion, a triazolium ion, an isoxazolium ion, an oxazolium ion, a thiazolium ion, an isothiazolium ion, an oxadiazolium ion, an oxatriazolium ion, a dioxazolium ion, an oxathiazolium ion, an indolium ion, an indazolium ion, a benzopyrrolidinium ion, a benzimidazolium ion, a benzotriazolium ion, a benzoisoxazolium ion, a benzoxazolium ion, a benzothiazolium ion, a benzisothiazolium ion, a benzoxadiazolium ion, a benzoxatriazolium ion, a benzodioxazolium ion, a benzoxathiazolium ion, a carbozolium ion, a purinium ion, a pyridinium ion, a pyridadinium ion, a pyrimidinium ion, a pyradinium ion, a piperazinium ion, a triazinium ion, an oxazinium ion, a piperizinium ion, an oxathiazinium ion, an oxadiazinium ion, a morpholinium ion, an isoquinolinium ion, a quinolinium ion, a cinnolium ion, a quinazolinium ion, a benzopyrazinium ion, a benzopiperazinium ion, a benzotriazinium ion, a benzoxazinium ion, a benzopiperizinium ion, a benzoxathiazinium ion, a benzoxadizinium ion, a benzomorpholinium ion, a naphthylidinium ion, an acridinium ion, an azepinium ion and a diazepinium ion. However, the present invention is not limited to these heterocyclic cations.

The heterocyclic cation is preferably a quaternary ammonium ion, and an imidazolium-type quaternary ammonium ion is particularly preferable. The imidazolium-type quaternary ammonium salt is an ionic liquid, and is ionically dissociated even in the state of non-solvent to such an extent that the imidazolium-type quaternary ammonium is ionically dissociated in an electrolytic solution, thereby further promoting the ionic dissociation. Accordingly, the speed of response of an ionic polymer gel, into which an imidazolium-type quaternary ammonium salt is introduced, can be increased.

In the present invention, the structure of an imidazolium-type quaternary ammonium salt group is not particularly limited as far as the imidazolium-type quaternary ammonium salt group is a salt formed from a cation having an imidazole ring. The imidazole ring may have a substituent. As the substituent, an alkyl group and other aromatic rings such as a phenyl group may be exemplified, and an imidazole ring having an alkyl group as a substituent is preferable from the viewpoint of enhancing the affinity of a highly polar ionic group for a hydrophobic solvent. The alkyl group as a substituent of the imidazole ring is preferably a straight-chained or branched alkyl group having 6 to 36 carbon atoms, more preferably a straight-chained or branched alkyl group having 8 to 22 carbon atoms, and still more preferably a straight-chained or branched alkyl group having 10 to 18 carbon atoms.

As the counter ion to be combined with the quaternary ammonium ion, a bromine ion, the following Anion (I), PF₆⁻, BF₄⁻, SbF₆⁻, (CF₃SO₂)₂N⁻, a sulfuric acid ion, a sulfite ion, a phosphoric acid ion, a phosphonic acid ion, a chlorine ion, bromine ion, an iodine ion, a fluorine ion, a perchloric acid ion, a perbromic acid ion, a periodic acid ion, a chloric acid ion, a bromic acid ion, and an iodic acid ion are preferable, and a bromine ion, chlorine ion, iodine ion, and the following Anion (I) are more preferable, and, the following Anion (I) is particularly preferable for delocalizing the charge widely:

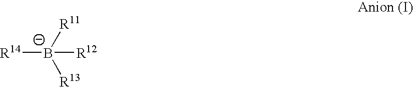

In Anion (I) in the above, R¹¹, R¹², R¹³ and R¹⁴ each independently represent an aromatic ring group which may have one or plural substituents, a halogen atom or an alkyl group which may have a substituent.

The aromatic group represented by R¹¹, R¹², R¹³ or R¹⁴ is preferably a phenyl group, a 1-naphthyl group, a 2-naphthyl group, a thiophene-2-il group, a thiophene-3-il group, a thiazole-2-il group, a thiazole-3-il group, a pyridine-2-il group, a pyridine-3-il group, a benzofuran-2-il group, a benzofuran-3-il group, a benzofuran-5-il group, a benzofuran-6-il, a benzothiophene-2-il group, a benzothiophene-5-il group, a benzothiophene-6-il group, a pyrimidine-2-il group, a pyrimidine-5-il group, a pyrazine-2-il group, a pyrazine-5-il group, a pyridazine-3-il group, a pyridazine-6-il group, an imidazole-2-il group, an imidazole 4-il group or an imidazole-5-il group; more preferably a phenyl group, a 1-naphthyl group, a 2-naphthyl group, a thiophene-2-il group, a thiophene-3-il group or an imidazole-2-il group; and still more preferably a phenyl group.

A substituent of the aromatic group represented by R¹¹, R¹², R¹³ or R¹⁴ is preferably an alkyl group, a fluoroalkyl group, an alkoxy group, an alkoxy carbonyl group, an alkyl carbonyloxy group, an alkyl carbamate group, an alkyl urea group, an alkyl amide group, a carbamoyl group, an alkyl imide group, a monoalkyl amino group, a dialkyl amino group, an alkylthio group or a halogen atom; more preferably an alkyl group having 1 to 30 carbon atoms, a fluoroalkyl group having 1 to 30 carbon atoms or a halogen atom; and still more preferably a methyl group an ethyl group, an isopropyl group, a t-butyl group, a trifluoromethyl group, a fluorine atom, a chlorine atom, a bromine atom or an iodine atom.

The halogen atom represented by R¹¹, R¹², R¹³ or R¹⁴ is preferably a fluorine atom, a chlorine atom, a bromine atom, or an iodine atom, and more preferably a fluorine atom.

The number of carbon atoms of the alkyl group represented by R¹¹, R¹², R¹³ or R¹⁴ is preferably from 1 to 30, more preferably from 3 to 22, and still more preferably from 6 to 18.

A substituent of the alkyl group represented by R¹¹, R¹², R¹³ or R¹⁴ is preferably a halogen atom, a phenyl group, a 1-naphthyl group, a 2-naphthyl group, an alkoxy group, an alkyloxy carbonyl group, an alkyl carbonyloxy group, an alkyl carbamate group, an alkylurea group, an alkylamide group, a carbamoyl group, an alkylimide group, a monoalkylamino group, a dialkylamino group or an alkylthio group; more preferably a halogen atom, a phenyl group, a 1-naphthyl group, a 2-naphthyl group or an alkyl ether group; and still more preferably a halogen atom or a phenyl group.

Among them, as the aromatic ring group represented by R¹¹, R¹², R¹³ and R¹⁴, an unsubstituted aromatic ring group, an aromatic ring group substituted with a fluoroalkyl group having 1 to 22 carbon atoms, or an aromatic ring group substituted with a fluorine atom is preferable.

R¹¹, R¹², R¹³ and R¹⁴ may be the same or different, and it is preferable that R¹¹, R¹², R¹³ and R¹⁴ are the same, from the viewpoint of the availability owing to the ease of synthesis of Anion (I).

Preferable examples of Anion (I) include tetraphenyl borate, tetrakis(3,5-bis(trifluoromethyl)phenyl)borate and tetrafluoro borate. Among them, tetraphenyl borate and tetrakis(3,5-bis(trifluoromethyl)phenyl)borate are preferable from the viewpoint of an increase in the degree of ionic dissociation attributable to the delocalization of the anionic negative charge.

In addition, the counter ion of an imidazolium quaternary ammonium salt group is preferably Anion (I) having an aromatic group, from the viewpoint of promoting the ionic dissociation due to the reduction in the electrostatic interaction between the positive charge and the negative charge in the ionic group.

From the viewpoint of the compatibility of a high affinity for the hydrophobic solvent and the electric responsiveness to an applied voltage, the ratio of the hydrophobic group to the ionic group (the hydrophobic group:the ionic group) is preferably from 50:50 to 90:10, more preferably 50:50 to 80:20, still more preferably 60:40 to 80:20, and particularly preferably 64:36 to 75:25, by molar ratio.

Furthermore, the ionic polymer gel in the present invention has preferably hydrophilic moieties. The ionic dissociation is promoted by adding hydrophilic moieties to the ionic polymer gel, and the swelling-contracting ratio of the polymer gel can be improved. When a hydrophobic solvent is used, even if hydrophilic moieties are introduced into a polymer gel, it is generally assumed that the swelling-contracting ratio is not influenced at all. However, in fact, the swelling-contracting ratio is increased in the ionic polymer gel into which hydrophilic groups are introduced. It is presumably that the hydrophilic groups are coordinated to the ionic groups, and the dissociation of the counter ion is promoted, but the present invention is not limited to the presumption.

As the hydrophilic moiety, a polyethyleneoxy group or a polypropyleneoxy group is preferable, and a polyethyleneoxy group is more preferable.

It is preferable that the polyethyleneoxy group or the polypropyleneoxy group has a hydrophobic group at the terminal end thereof from the viewpoint of the affinity for the hydrophobic solvent; and the hydrophobic group is preferably a straight-chained, branched or cyclic alkyl group having 1 to 36 carbon atoms, more preferably straight-chained or branched alkyl group having 1 to 12 carbon atoms, and particularly preferably a straight-chained alkyl group having 1 to 4 carbon atoms.

The number of repeating units of the polyethyleneoxy group is preferably from 2 to 15, more preferably from 2 to 10, and still more preferably from 4 to 8.

The number of repeating units of the polypropyleneoxy group is preferably from 2 to 12, more preferably from 2 to 8, and still more preferably from 4 to 6.

It is preferable that the ratio of the molar number of the hydrophilic group to the total molar number of the ionic group and the hydrophobic group [(hydrophilic group):(the ionic group+hydrophobic group)] is from 5:95 to 30:70, from the viewpoint of the ionic dissociation and the affinity for the hydrophobic solvent, more preferably from 10:90 to 30:70, and still more preferably from 10:90 to 20:80.

The ionic polymer gel has a network structure formed by cross-linking the polymer having the above structure. In order to enhance the swellability of the polymer gel, it is preferable to make the crosslink density low.

In the ionic polymer gel in the present invention, the structure of the cross-linking agent is not specifically limited.

The skeleton structure of the main chain of the polymer having the above structure is not specifically restricted. Among them, an acrylate polymer, a methacrylate polymer, a vinyl ether polymer, a styrene polymer, an epoxy polymer and an oxethane polymer are preferable, an acrylate polymer and a methacrylate polymer are more preferable, and an methacrylate polymer is still more preferable in view of good gelation.

It is preferable that the polymer gel includes the polymer compound having the repeating structure represented by the following Formula (1) or (2);

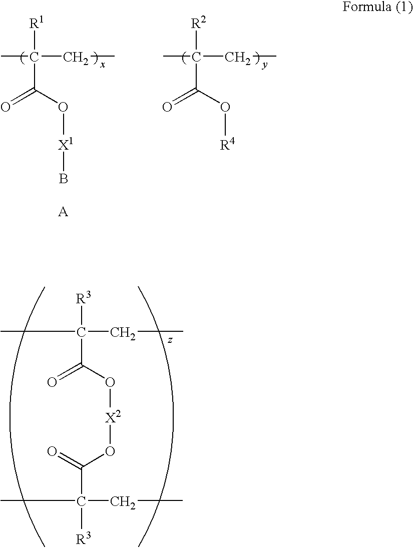

In the Formula (1), R¹, R² and R³ each independently represent a hydrogen atom or an alkyl group; and R⁴ represents a straight-chained, branched or cyclic alkyl group. X¹ and X² each independently represent a divalent linking group. B represents a cation or an anion; and A represents a counter ion therefor. x, y and z each represent molar %, and in the present invention, the molar ratio represented by x, y and z is not specifically restricted, as far as the repeating unit represented by the Formula (1) is contained. It is preferable that x, y and z satisfy the following relationship of 0<x≦90, 0<y≦90, 0<z≦10, and 70≦x+y+z≦100.

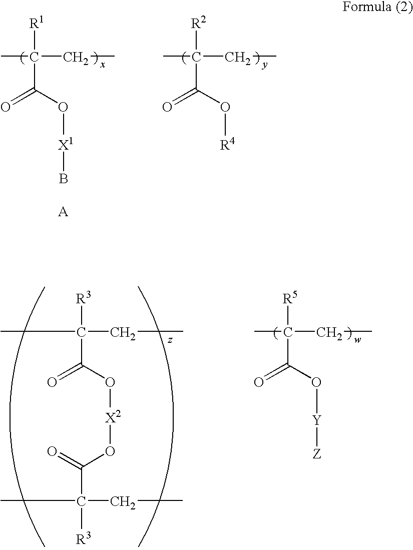

In the Formula (2), R¹, R², R³ and R⁵ each independently represent a hydrogen atom or an alkyl group. R⁴ represents a straight-chained, branched or cyclic alkyl group. X¹ and X² each independently represent a divalent linking group. B represents a cation or an anion, and A represents a counter ion therefor. Y represents a polyethyleneoxy group or a polypropyleneoxy group. Z represents a straight-chained, branched or cyclic alkyl group or a hydrogen atom. x, y, z and w each represent molar %, and in the present invention, the molar ratio represented by x, y, z and w is not specifically restricted, as far as the repeating unit represented by the Formula (2) is contained. It is preferable that x, y, z and w satisfy the following relationship of 0<x≦90, 0<y≦90, 0<z≦10, 0<w<30 and 70≦x+y+z<100.

In the Formulae (1) and (2), R¹, R² and R³ each independently represent a hydrogen atom or an alkyl group. In the Formula (2), R⁵ represents a hydrogen atom or an alkyl group. The number of carbon atoms of the alkyl group represented by R¹, R², R³ and R⁵ is preferably 1 to 12, more preferably 1 to 4, and a methyl group is particularly preferable.

R¹, R², R³ and R⁵ are preferably a hydrogen atom or a methyl group, and a methyl group is more preferable in view of the ease of gelation.

R⁴ in the Formulae (1) and (2) is preferably a straight-chained or branched alkyl group. The number of the carbon atoms in the alkyl group is preferably from 6 to 50, more preferably from 10 to 36, and still more preferably from 12 to 18.

The alkyl group represented by R⁴ may have a substituent, but preferably does not have a substituent.

R⁴ is preferably a straight-chained alkyl group from the viewpoint of the ease of gelation and the degree of swellability.

X¹ in the Formulae (1) and (2) represents a divalent linking group. X¹ is preferably an alkylene group, a (poly)ethyleneoxy group, or a (poly)propyleneoxy group having 2 to 12 carbon atoms, more preferably an alkylene group having 2 to 10 carbon atoms, and still more preferably an alkylene group having 3 to 6 carbon atoms. In the case of a linking group with such a length, it is presumed that the distance from the polymer skeleton to the ionic group is appropriately separated, and the degree of swelling of the gel becomes higher.

X² in the Formulae (1) and (2) represents a divalent linking group. X² is preferably an alkylene group, (poly)ethyleneoxy group or (poly)propyleneoxy group having 2 to 50 carbon atoms, more preferably an alkylene group or (poly)ethyleneoxy group having 2 to 20 carbon atoms, and still more preferably an alkylene group having 3 to 8 carbon atoms.

B in the Formulae (1) and (2) represents a cation or an anion bonded to the polymer chain with a covalent bond through the X¹.

When B is a cation, B is preferably a quaternary ammonium group or a heterocyclic group.

The quaternary ammonium group represented by B has preferably an alkyl group bonded directly to the nitrogen atom. The alkyl group bonded directly to the nitrogen atom imparts an affinity for a hydrophobic solvent to a highly polar ionic group.

The alkyl bonded directly to the nitrogen atom of the quaternary ammonium group is preferably a straight-chained or branched alkyl group having 6 to 36 carbon atoms, more preferably a straight-chained or branched alkyl group of the carbon numbers 8 to 22, and still more preferably a straight-chained alkyl group having 10 to 18 carbon atoms.

Examples of the heterocyclic group represented by B include, for example, a pyrrolium ion, a pyrazolium ion, a pyrrolidinium ion, an imidazolium ion, a triazolium ion, an isoxazolium ion, an oxazolium ion, a thiazolium ion, an isothiazolium ion, an oxadiazolium ion, an oxatriazolium ion, a dioxazolium ion, an oxathiazolium ion, an indolium ion, an indazolium ion, a benzopyrrolidinium ion, a benzimidazolium ion, a benzotriazolium ion, a benzoisoxazolium ion, a benzoxazolium ion, a benzothiazolium ion, a benzisothiazolium ion, a benzoxadiazolium ion, a benzoxatriazolium ion, a benzodioxazolium ion, a benzoxathiazolium ion, a carbozolium ion, a purinium ion, a pyridinium ion, a pyridadinium ion, a pyrimidinium ion, a pyradinium ion, a piperazinium ion, a triazinium ion, an oxazinium ion, a piperizinium ion, an oxathiazinium ion, an oxadiazinium ion, a morpholinium ion, an isoquinolinium ion, a quinolinium ion, a cinnolium ion, a quinazolinium ion, a benzopyrazinium ion, a benzopiperazinium ion, a benzotriazinium ion, a benzoxazinium ion, a benzopiperizinium ion, a benzoxathiazonium ion, a benzoxadizinium ion, a benzomorpholinium ion, a naphthylidinium ion, an acridinium ion, an azepinium ion and a diazepinium ion. However, B is not limited to these heterocyclic groups.

Among the above heterocyclic rings, the heterocyclic ring represented by B is preferably an imidazolium ion from the viewpoint of the speed of responsiveness and the degree of swellability.

The heterocyclic represented by B has preferably one or more alkyl groups at an arbitrary position. The alkyl group on the heterocyclic imparts an affinity for a hydrophobic solvent to a highly polar ionic group.

The alkyl group on the heterocyclic ring is preferably a straight-chained or branched alkyl group having 6 to 36 carbon atoms, more preferably a straight-chained or branched alkyl group having 8 to 22 carbon atoms, and still more preferably a straight-chained alkyl group having 10 to 18 carbon atoms.

The heterocyclic group represented by B is particularly preferably an imidazolium ion having a straight-chained alkyl group having 10 to 18 carbon atoms as a substituent.

On the other hand, when B is an anion, Anion (II) which may be alkyl-substituted, Anion (III) which may be alkyl-substituted, or Anion (IV), a phosphoric acid ion which may be alkyl-substituted, a phosphonic acid ion which may be alkyl-substituted, a carboxylic ion, a sulfite ion, a sulfate ion and the like may be exemplified.

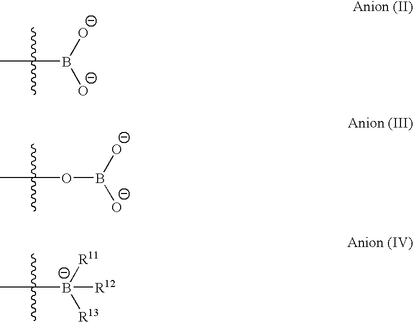

The wavy lines in the above anions (II), (III) and (IV) represent the linking position with X¹ in the Formulae (1) and (2).

In Anion (IV), R¹¹, R¹² and R¹³ are synonymous with R¹¹, R¹² and R¹³ in Anion (I), respectively, and the preferable ranges are also the same as those of Anion (I).

The alkyl group as a substituent of the phosphoric acid ion, the phosphonic acid ion, Anion (II) or Anion (III) has preferably 1 to 40 carbon atoms, more preferably 3 to 30 carbon atoms, and still more preferably 5 to 22 carbon atoms. The alkyl group may be any of a straight-chained, branched or cyclic alkyl group, and the alkyl group is preferably straight-chained in view of the degree of the affinity (hydrophobic interaction) for a hydrophobic solvent.

In addition, the alkyl-substituted phosphoric acid ion, phosphonic acid ion, Anion (II) and Anion (III) mean the following ion:

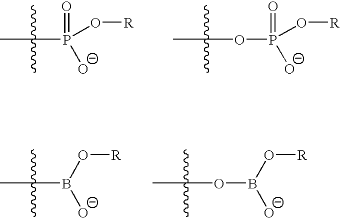

In the above Formulae, R represents an alkyl group as a substituent of the phosphoric acid ion, the phosphonic acid ion, Anion (II) or Anion (III).

In the Formulae (1) and (2), A represents a counter ion for the ionic species represented by B. When B is a cation, A represents an anion. For example, a halogen ion, Anion (I), a phosphoric acid ion, a phosphonic acid ion, a carboxylic ion, a sulfite ion, a sulfuric acid ion, PF₆⁻, SbF₆⁻, N(SO₂CF₃)₂⁻, ClO₄⁻ and SO₃CF₃⁻ are exemplified as A, and Anion (I) or a haloge ion is particularly preferable.

The preferable range of Anion (I) is described in the above, and preferable examples of Anion (I) include a tetraphenylborate ion, a tetrakis(3,5-bis(trifluoromethyl)phenyl)borate ion and a tetrafluoroborate ion. Anion (I) having an aromatic ring is more preferable for delocalizing the charge widely.

On the other hand, when B is an anion, A represents a cation. For example, an atom of the group I (alkali metal atoms) of the periodic table, an atom of the group II (alkaline earth metal atoms) of the periodic table, a quaternary ammonium ion, a pyrrolium ion, a pyrazolium ion, a pyrrolidinium ion, an imidazolium ion, a triazolium ion, an isoxazolium ion, an oxazolium ion, a thiazolium ion, an isothiazolium ion, an oxadiazolium ion, an oxatriazolium ion, a dioxazolium ion, an oxathiazolium ion, an indolium ion, an indazolium ion, a benzopyrrolidinium ion, a benzimidazolium ion, a benzotriazolium ion, a benzoisoxazolium ion, a benzoxazolium ion, a benzothiazolium ion, a benzisothiazolium ion, a benzoxadiazolium ion, a benzoxatriazolium ion, a benzodioxazolium ion, a benzoxathiazolium ion, a carbozolium ion, a purinium ion, a pyridinium ion, a pyridadinium ion, a pyrimidinium ion, a pyradinium ion, a piperazinium ion, a triazinium ion, an oxazinium ion, a piperizinium ion, an oxathiazinium ion, an oxadiazinium ion, a morpholinium ion, an isoquinolinium ion, a quinolinium ion, a cinnolium ion, a quinazolinium ion, a benzopyrazinium ion, a benzopiperazinium ion, a benzotriazinium ion, a benzoxazinium ion, a benzopiperizinium ion, a benzoxathiazonium ion, a benzoxadizinium ion, a benzomorpholinium ion, a naphthylidinium ion, an acridinium ion, an azepinium ion and a diazepinium ion are exemplified as A.

In addition, these ions may be unsubstituted, or may be substituted with an alkyl group, an aryl group, an acyl group, an alkoxy group, an aryloxy group, a halogen atom, a mercapto group, an amino group, a hydroxyl group, an azo group, a cyano group, a carboxyl group, an alkoxycarbonyl group, an aryloxy carbonyl group, a halocarbonyl group, or a combination therewith.

In the Formulae (1) and (2), x, y, z and w represent molar %. The molar ratio represented by x, y, z and w is not specifically restricted, as far as the polymer compound contains the repeating units represented by the Formula (1) or (2). It is preferable that x, y and z in the Formula (1) satisfy the following relationship;

0<x≦90, 0<y≦90, 0<z≦10 and 70≦x+y+z≦100.

Further, it is preferable that x, y, z and w in the Formula (2) satisfy the following relationship;

0<x≦90, 0<y≦90, 0<z≦10, 0<w<30 and 70≦x+y+z≦100.

The value of x in the Formulae (1) and (2) means the introduction rate of ionic groups. The introduction rate is an important factor which can influence the quantity of swelling and contracting of gel particles when a voltage is applied, and as the rate of x is increased, the voltage-responsiveness is increased.

The value of y in the Formulae (1) and (2) means the introduction rate of hydrophobic monomers. As the rate of y is increased, the swellability (affinity) in a hydrophobic solvent is improved.

The value of z in the Formulae (1) and (2) means the introduction rate of crosslinkable monomers. As the rate of z is reduced, the crosslink density is lowered, and the swellability in a solvent is increased.

In the voltage-responsive polymer gel of the present invention, the quantity of swelling and contracting is increased, whereby the degree of ionic dissociation is increased, the affinity for a hydrophobic solvent is enhanced, and a cross-linking density is reduced. Accordingly, two parameters of the “degree of ionic dissociation dominated by the rate of x”, and the “affinity for the hydrophobic solvent dominated by the rate of y” have a trade-off relationship with each other.

Further, by the research of the inventors, it has become clear that in the ionic polymer gel in the present invention, when the swellability in the solvent is increased at the time of applying no voltage, the swelling-contracting ratio is enhanced at the time of applying voltage. Accordingly, in order to increase the swelling-contracting ratio, it is preferable to design a polymer gel such that the three-dimensional network of a cross-linked gel is made sparse, and a number of solvent molecules can penetrate into the spaces among the network.

In view of the above, for the purpose of increase in the swelling-contracting ratio, it is preferable to reduce the crosslink density. In order to reduce the crosslink density, it is effective to make z smaller or to make X² larger in the Formula (1) or (2).

In view of the above, the preferable ratio of x, y and z is expressed as follows.

The range of x is preferably from 5 mole % to 60 mole %, more preferably from 10 mole % to 50 mole %, and still more preferably from 20 mole % to 40 mole %.

The range of y is preferably from 50 mole % to 90 mole %, more preferably from 60 mole % to 90 mole %, and still more preferably from 65 mole % to 90 mole %.

The range of z is preferably from 0.01 mole % to 3 mole %, more preferably from 0.05 mole % to 1 mole %, further more preferably from 0.05 mole % to 0.8 mole %, still more preferably from 0.1 mole % to 0.7 mole %, and further still more preferably from 0.2 mole % to 0.6 mole %.

The compounds represented by Formulae (1) and (2) may contain other constituent units, and the constituent units include polymerizable monomers such as styrene which may have a substituent, and acrylamide which may have a substituent. The amount of introduction of the other constituent units is preferably from 0 mole % to less than 30 mole %, more preferably from 0 mole % to 20 mole %, still more preferably from 0 mole % to 15 mole %.

The total molar % of x, y and z[(x+y+z)] in the Formula (1) is preferably from 70 mole % to 100 mole %, from the viewpoint of the sensitivity and the swellability, more preferably from 75 mole % to 100 mole %, and still more preferably from 80 mole % to 100 mole %.

The total molar % of x, y and z[(x+y+z)] in the Formula (2) is preferably from 70 mole % to less than 100 mole %, from the viewpoint of the sensitivity and the swellability.

Further, w in the Formula (2) means the introduction rate of the hydrophilic monomer. The ionic dissociation is promoted by imparting suitably the hydrophilicity to the inside of the ionic polymer gel, and the quantity of swelling-contracting increases. The preferable range of w for imparting the hydrophilicity to the inside of the ionic polymer gel while enhancing the affinity for the hydrophobic solvent is from 5 mole % to 30 mole %, and more preferably from 10 mole % to 20 mole %.

Y in the Formula (2) represents a polyethyleneoxy group (—(OCH₂CH₂)ₙ—) or a polypropyleneoxy group (—(OCH₂CH(CH₃))ₙ—).

A polyethyleneoxy group having repeating units number n of 2 to 15 is preferable, a polyethyleneoxy group having repeating units number n of 3 to 10 is more preferable, and a polyethyleneoxy group having repeating units number n of 4 to 8 is still more preferable.

Z in the Formula (2) represents a straight-chained or branched alkyl group, or a hydrogen atom.

Z is preferably a methyl group, an ethyl group or a straight-chained or branched alkyl group having 3 to 22 carbon atoms, or a hydrogen atom, more preferably a methyl group, an ethyl group or a straight-chained or branched alkyl group having 3 to 12 carbon atoms, or a hydrogen atom, and still more preferably a methyl group, an ethyl group or a straight-chained alkyl group having 3 to 8 carbon atoms, from the viewpoint of the affinity for the hydrophobic solvent.

Hereinafter, examples of the polymer structure are exemplified, but the present invention is not limited to these polymer structures.

| | | | |
|---|---|---|---|
| 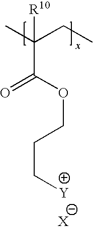 | 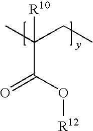 | 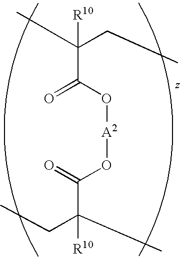 | 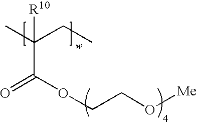 |

| No. | X⊖ | x | y | z | w | R¹⁰ | Y⊕ | R¹² | A² |
|---|---|---|---|---|---|---|---|---|---|
| 1 | ⊖Br | 15 | 84.4 | 0.6 | 0 | H | ⊕N(n-C₈H₁₇)₃ | n-C₁₈H₃₇ | —(CH₂)₂— |
| 2 | ⊖Br | 30 | 54.6 | 0.4 | 15 | Me | ⊕N(n-C₁₂H₂₅)₃ | n-C₁₈H₃₇ | —(CH₂)₂— |
| 3 | ⊖BPh₄ | 30 | 54.6 | 0.4 | 0 | Me | ⊕N(n-C₁₈H₃₇)₃ | n-C₁₂H₃₇ | —(CH₂)₂— |
| 4 | ⊖BPh₄ | 30 | 54.6 | 0.4 | 15 | Me | ⊕N(n-C₁₂H₂₅)₃ | n-C₁₈H₃₇ | —(CH₂)₄— |
| 5 | ⊖BPh₄ | 30 | 54.6 | 0.4 | 15 | Me | ⊕N(n-C₁₂H₂₅)₃ | n-C₂₂H₄₅ | —(CH₂)₈— |
| 6 | ⊖BPh₄ | 45 | 54.6 | 0.4 | 15 | H | ⊕N(CH₃)Ph₂ | n-C₁₈H₃₇ | —(CH₂)₁₂— |
| 7 | ⊖BPh₄ | 30 | 54.6 | 0.4 | 15 | Me | ⊕N(n-C₁₈H₃₇)₃ | 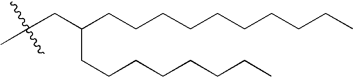 | —CH₂CH₂OCH₂CH₂— |
| 8 | ⊖BPh₄ | 30 | 54.6 | 0.4 | 15 | Me | ⊕N(n-C₁₈H₃₇)₃ | n-C₂₂H₄₅ | —(CH₂CH₂O)₇CH₂CH₂— |
| 9 | ⊖TFPB | 15 | 84.4 | 0.6 | 0 | Me | ⊕N(n-C₁₂H₂₅)₃ | n-C₁₈H₃₇ | —(CH₂)₂— |
| 10 | ⊖TFPB | 30 | 54.6 | 0.4 | 15 | H | ⊕N(n-C₁₂H₂₅)₃ | 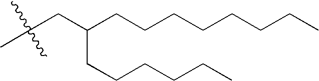 | —(CH₂)₂— |
| 11 | ⊖TFPB | 30 | 54.6 | 0.4 | 15 | Me | ⊕N(CH₃)Ph₂ | n-C₂₂H₄₅ | —(CH₂CH₂O)₃CH₂CH₂— |

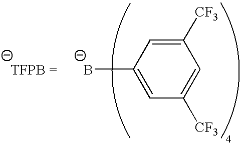

| | | | |
|---|---|---|---|
| 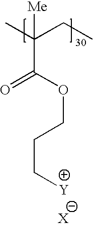 | 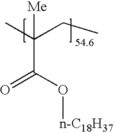 | 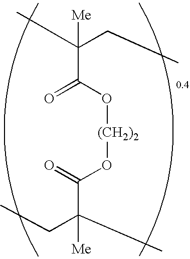 | 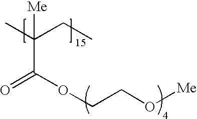 |

| No. | X⊖ | Y⊕ |
|---|---|---|
| 12 | Br⁻ | 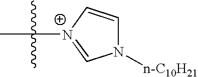 |
| 13 | Br⁻ | 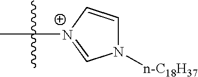 |
| 14 | ⁻BPh₄ | 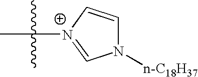 |
| 15 | ⁻BPh₄ | 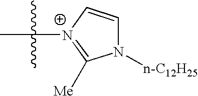 |
| 16 | Br⁻ | 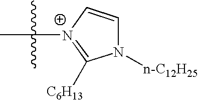 |
| 17 | ⁻BPh₄ | 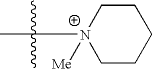 |
| 18 | ⁻BPh₄ | 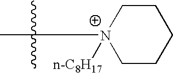 |
| 19 | ⁻BPh₄ | 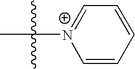 |
| 20 | ⁻BPh₄ | 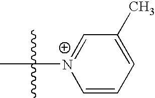 |
| 21 | ⁻BPh₄ | 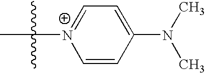 |
| 22 | ⁻BPh₄ | 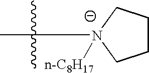 |
| 23 | ⁻BPh₄ | 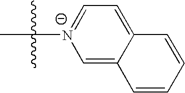 |
| 24 | ⁻BPh₄ | 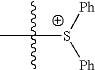 |

| | | | |
|---|---|---|---|
| 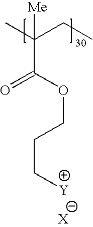 | 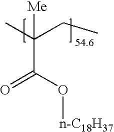 | 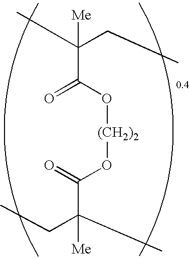 | 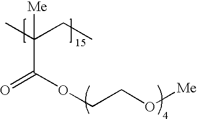 |

| No. | X⊕ | Y⊖ |
|---|---|---|
| 25 | ⊕N(CH₃)(n-C₁₂H₂₅)₃ | 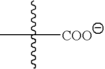 |
| 26 | ⊕P(CH₃)(n-C₆H₁₃)₃ | 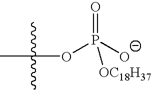 |
| 27 | 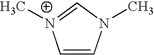 | 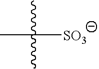 |
| 28 | 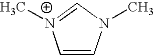 | 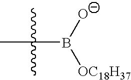 |
| 29 | 2 ⊕N(CH₃)(n-C₁₈H₃₇)₃ | 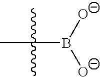 |

The wavy lines represent the bonding positions in the above polymer structure.

When the polymer gel-containing composition of the present invention is applied to a light modulating device or a display element, it is preferable that the change in volume of the ionic polymer is large, and the volumetric ratio at the time of swelling and at the time of contracting is 5 or more, more preferably 10 or more, and further more preferably 15 or more. The volumetric ratio within the range will become sufficient for the contrast for an optical element and the like.

The usage form of the polymer gel of the present invention is not particularly restricted, but a variety of forms such as particle, block, film, indefinite and fibrous forms may be used. In particular, particle form is particularly preferable from the viewpoint of a high color-forming property and a high responsiveness when applied to a light modulating device or a display device.

The shape in the particle form is not particularly restricted, but spherical, elliptic, polyhedral, porous, fibrous, star-shaped, needle-shaped and hollow shapes may be used.

Moreover, in the case that the ionic polymer gels are particles, a preferable average size is in the range of from 0.01 μm to 5 mm, and more preferably in the range of from 0.01 μm to 1 mm. When the particle size is within the range, the particles excel in handling, and in optical characteristics as well. Moreover, the speed of response is also good.

These particles are manufactured by a method of milling a polymer gel by a physical milling method, a method of forming a gel by cross-linking particles after forming the particles by granulating a polymer by a chemical granulating method prior to cross-linking, or general methods such as an emulsion polymerization method, a suspension polymerization method, and a dispersion polymerizing method.

In the present invention, the polymerization reaction is carried out preferably in the presence of a non-metal polymerization initiator. For example, a compound having polymerizable carbon-carbon double bonds can be polymerized in the presence of a polymerization initiator that exhibits an activity by generating free radicals such as a carbon radical and an oxygen radical by heating.

As the polymerization initiator, an organic peroxide or an organic azo compound is preferably used, and an organic azo compound is preferable. However, the polymerization initiator used in the present invention is not limited to these polymerization initiators.

The organic azo compounds include azo nitrile compounds such as V-30, V-40, V-59, V-65 and V-70; azo amide compounds such as VA-080, VA-085, VA-086, VF-096, VAm-110 and VAm-111; cyclic azo amidine compounds such as VA-044 and VA-061; and azo amidine compounds such as V-50 and VA-057 ((trade names) commercially available from Wako Pure Chemical Industries, Ltd.); 2,2-azobis(4-methoxy-2,4-dimethylvaleronitrile), 2,2-azobis(2,4-dimethylvaleronitrile), 2,2-azobis(2-methylpropionitrile), 2,2-azobis(2,4-dimethylbutylonitrile), 1,1-azobis(cyclohexane-1-carbonitrile), 1-[(1-cyano-1-methylethyl)azo]formamide, 2,2-azobis{2-metyl-N-[1,1-bis(hyroxymethyl)-2-hydroxyethyl]propionamide}, 2,2-azobis[2-methyl-N-(2-hydroxybutyl)propionamide], 2,2-azobis[N-(2-propenyl)-2-methylpropionamide], 2,2-azobis(N-butyl-2-methylpropionamide), 2,2-azobis(N-cyclohexyl-2-methylpropionamide), 2,2-azobis[2-(2-imidazoline-2-il)propane]dihydrochloride, 2,2-azobis[2-(2-imidazoline-2-il)propane]disulfate dihydrate, 2,2-azobis{2-[1-(2-hydroxyethyl)-2-imidazoline-2-il]propane}dihydrochloride, 2,2-azobis[2-(2-imidazoline-2-il)propane], 2,2-azobis(1-imino-1-pryrrolidino-2-methylpropane)dihydrochloride, 2,2-azobis(2-methylpropioneamidine)dihydrochloride, 2,2-azobis[N-(2-carboxyethyl)-2-methylpropioneamidine]tetrahydrate, dimethyl-2,2-azobis(2-methylpropionate), 4,4-azobis(4-cyanovaleric acid), and 2,2-azobis(2,4,4-trimethylpentane).

Preferable examples of organic peroxides include ketone peroxides such as PERHEXA H; peroxy ketals such as PERHEXA TMH, hydroperoxides such as PERBUTYL H-69, dialkyl peroxides such as PERCUMYL D, PERBUTYL C and PERBUTYL D, diacyl peroxides such as NYPER BW, peroxyesters such as PERBUTYL Z and PERBUTYL L, peroxydicarbonates such as PEROYL TCP ((all are trade names) commercially available from NOF Corporation); diisobutyryl peroxide, cumylperoxy neodecanoate, di-n-propylperoxy dicarbonate, diisopropylperoxy dicarbonate, di-sec-butylperoxy dicarbonate, 1,1,3,3-tetramethyl butylperoxy neodecanoate, di(4-t-butylcyclohexyl)peroxy dicarbonate, di(2-ethylhexyl)peroxy dicarbonate, t-hexyl peroxy neodecanoate, t-butyl peroxy neodecanoate, t-butyl peroxy neoheptanate, t-hexyl peroxy pivalate, t-butyl peroxy pivalate, di(3,3,5-trimethyl hexanoyl)peroxide, dilauroylperoxide, 1,1,3,3-tetramethyl butylperoxy-2-ethyhexanoate, disuccinic acid peroxide, 2,5-dimethyl-2,5-di(2-ethylhexanoylperoxy)hexane, t-hexylperoxy-2-ethylhexanoate, di(4-methylbenzoyl)peroxide, t-butylperoxy-2-ethylhexanoate, di(3-methylbenzoyl)peroxide, benzoyl(3-methylbenzoyl)peroxide, dibenzoylperoxide, 1,1-di(t-butylperoxy)-2-methylcyclohexane, 1,1-di(t-hexylperoxy)-3,3,5-trimethylcyclohexane, 1,1-di(t-hexylperoxy)cyclohexane, 1,1-di(t-butylperoxy)cyclohexane, 2,2-di(4,4-di(t-butylperoxy)cyclohexyl)propane, t-hexylperoxyisopropyl monocarbonate, t-butylperoxy maleic acid, t-butyperoxy-3,5,5-trimethyl hexanoate, t-butyulperoxy laurate, t-butylperoxy isopropyl monocarbonate, t-butylperoxy-2-ethylhexyl monocarbonate, t-hexylperoxy benzoate, 2,5-di-methyl-2,5-di(benzoylperoxy)hexane, t-butylperoxy acetate, 2,2-di(t-butylperoxy)butane, t-butylperoxy benzoate, n-butyl-4,4-di-t-butylperoxyvaleate, di(2-t-butylperoxyisopropyl)benzene, dicumyl peroxide, di-t-hexylperoxide, 2,5-dimethyl-2,5-di(t-butylperoxy)hexane, t-butylcumyl peroxide, di-t-butyl peroxide, p-methane hydroperoxide, 2,5-dimethyl-2,5-di(t-butylperoxy)hexine-3, diisopropylbenzene hydroperoxide, 1,1,3,3-tetramethylbutyl hydroperoxide, cumene hydroperoxide, t-butylhydroperoxide, 2,3-dimethyl-2,3-diphenyl butane, 2,4-dichlorobenzoyl peroxide, o-chhlorobenzoyl peroxide, p-chlorobenzoyl peroxide, tris-(t-butylperoxy)triazine, 2,4,4-trimethylpentylperoxy neodecanoate, α-cumylperoxy neodecanoate, t-amylperoxy-2-ethylhexanoate, t-butylperoxy isobutylate, di-t-butylperoxy hexahydroterephthalate, di-t-butylperoxy trimethyladipate, di-3-methoxybutylperoxy dicarbonate, di-isopropylperoxy dicarbonate, t-butylperoxy isopropylcarbonate, 1,6-bis(t-butylperoxycarbonyloxy)hexane, diethyleneglycol-bis(t-butylperoxycarbonate), and t-hexylperoxy neodecanoate.

In the present invention, the polymerization initiator may be used singly, or two or more kinds thereof may be used in combination. In the present invention, the use amount of the polymerization initiator is preferably from 0.001 mole % to 3 mole %, more preferably from 0.05 mole % to 2 mole %, and particularly preferably from 0.1 mole % to 1.5 mole %.

Although the optimal conditions of the polymerization reaction in the present invention vary with the kind of polymerization initiator, compound and solvent, concentration and the like, the temperature inside a reaction vessel is preferably from 0° C. to 150° C., more preferably from 20° C. to 100° C., and particularly preferably from 40° C. to 80° C., and the reaction time of polymerization is preferably in the range of from 0.5 to 20 hours, more preferably from 1 to 12 hours, and particularly preferably from 1.5 to 8 hours.

Further, in order to prevent inactivation of a polymerization initiator due to oxygen, the reaction is preferably carried out react under an inert gas atmosphere (for example, nitrogen, argon or the like), and the concentration of oxygen at the time of the reaction is preferably 500 ppm or less, more preferably 200 ppm or less, and particularly preferably 100 ppm or less.

The reaction solvent at the time of polymerization of the present invention is not specifically limited. The solvents include, for example, alcohol-based solvents such as methanol, ethanol, 2-propanol, 1-butanol, 2-ethoxy methanol, 3-methoxy propanol, and 1-methoxy-2-propanol; ketone-based solvents such as acetone, acetyl acetone, methyl ethylketone, methyl isobutylketone, methyl-t-butylketone, 2-pentanone, 3-pentanone, 2-heptanone, 3-heptanone, cyclopentanone and cyclohexanone; ester-based solvents such as ethyl acetate, propyl acetate, butyl acetate, isobutyl acetate, pentyl acetate, ethyl propionate, propyl propionate, butyl propionate, isobutyl propionate, propyleneglycol monomethyl ether acetate, methyl lactate, ethyl lactate and γ-butyrolactone; ether-based solvents such as tetrahydrofuran, dioxane, dimethoxyethane, diethoxyethane, diglyme, triglyme, tetraglyme, diisopropyl ether, dibutyl ether, ethyl propyl ether, anisole, phenetole and veratrole; aromatic hydrocarbon-based solvents such as benzene, toluene, xylene, mesitylene, ethylbenzene, diethylbenzene, propylbenzene and t-butyl benzene; halogen-based solvents such as methylene chloride, chloroform, bromoform and carbon tetrachloride; saturated hydrocarbon-based solvents such as ISOPAR M ((registered trademark) manufactured by Exxon Mobil Corporation) and liquid paraffin; amide-based solvents such as N-methyl pyrrolidinone, dimethyl acetamide and dimethyl formamide; and mineral oil. The solvents may be used singly, or two or more kind of the solvents may be used in combination.

More preferable organic solvents are tetrahydrofuran, dioxane, dimethoxy ethane, diethoxy ethane, benzene, toluene, xylene, mesitylene, ethylbenzene, diethyl benzene, propyl benzene, t-butyl benzene, chloroform, bromoform, carbon tetrachloride, ISOPAR M (registered trademark), liquid paraffin and a mineral oil, and particularly preferable solvents are tetrahydrofuran, toluene, xylene, mesitylene and ISOPAR M (registered trademark).

The concentration of monomer at the time of polymerization in the solvent of the present invention is preferably from 20% by mass to 80% by mass, more preferably from 30% by mass to 70% by mass, and particularly preferably from 40% by mass to 60% by mass.

As the polymerization method of the polymer gel of the present invention, for example, a lump polymerizing method in which monomers and an initiator are dissolved in a solvent, and the solution is heated to be polymerized, and a dropping polymerizing method in which a solution of monomer and an initiator is added dropwise to a heated solvent over 0.5 to 10 hours, may be exemplified, and the lump polymerizing method is preferable.

As the method of taking out the polymer gel after polymerization reaction, in general, the polymer gel can be taken out by being scraped out physically, because the gel is in the state where the gel is swollen by absorbing almost whole reaction solvents at the end of polymerization. After taking out the swollen gel, an operation such as the suction filtration, decantation and centrifugal separation for removing an excess solvent is preferably performed, and the suction filtration is particularly preferable. However, in the case where the filtration is difficult due to clogged filter paper in the suction filtration, removal of the solvent by the centrifugal separation is also preferable.

For the purpose of removing unreacted monomer component, after taking out the gel in a swollen state, it is preferable to wash the swollen gel with the same solvent as the reaction solvent by the suction filtration or centrifugal separation.

After washing the swollen gel obtained in the above, the swollen gel is preferably dried in order to remove the residual solvent. The drying temperature is preferably from 50° C. to 200° C., more preferably 60° C. to 180° C., and further more preferably 70° C. to 150° C. In addition, in order to shorten drying time, the swollen gel may be dried under reduced pressure.

It is preferable to synthesize the polymer gel of the present invention by a suspension polymerization, from the viewpoint of obtaining spherical and fine particles having a high responsiveness to voltage. In the suspension polymerization, the polymer gel can be formed by adding dropwise monomer dissolved in the organic solvent to water.

The reaction temperature in the suspension polymerization is preferably from 0° C. to 120° C., more preferably from 20° C. to 90° C., and still more preferably from 40° C. to 80° C.

The reaction time of the suspension polymerization is preferably in the range of from 0.5 to 20 hours, more preferably in the range of from for 1 to 12 hours, and particularly preferably in the range of from 1.5 to 8 hours.

As the suspension polymerization method of the present invention, a polymerization condition of a W/O (oil in water) system in which a small amount of liquid droplets of a hydrophobic solvent is suspended in an aqueous solution is preferable. In this case, it is necessary that components such as the monomer and a polymerization initiator are dissolved in the liquid droplets of the hydrophobic solvent. The content of the hydrophobic solvent in the suspension polymerization method is preferably in the range of from 0.05% by weight to 30% by weight, more preferably from 0.5% by weight to 20% by weight, and still more preferably from 1 by weight to 10% by weight.

The reaction solvent at the time of the suspension polymerization of the present invention is not specifically limited. The solvents include, for example, ketone-based solvents such as cyclohexanone; aromatic hydrocarbon-based solvents such as benzene, toluene, xylene, mesitylene, ethylbenzene, diethylbenzene, propylbenzene and t-butyl benzene; halogen-based solvents such as methylene chloride, chloroform, bromoform and carbon tetrachloride; and saturated hydrocarbon-based solvents such as ISOPAR M ((registered trademark) manufactured by Exxon Mobil Corporation) and liquid paraffin; and mineral oil. These solvents may be used singly, or two or more kind of the solvents may be used in combination.

In the suspension polymerization of the present invention, in order to enhance the stability of suspension particles, components other than monomer as a raw material or a polymerization initiator may be dissolved/dispersed in a hydrophobic solvent or an aqueous solution. Such other components are not specifically restricted, but for example, a water-soluble resin, a nonionic surfactant, an amphoteric surfactant, an anionic surfactant, a fluorine-based surfactant, a silicone-based surfactant and the like are exemplified. The surfactants may be used singly, or two or more kind of the surfactants may be used in combination.

Examples of the water-soluble binders include, for example, polyvinyl alcohol-based resins which have a hydroxyl group as a hydrophilic structural unit [polyvinyl alcohol (PVA), acetoacetyl-modified polyvinyl alcohol, cation-modified polyvinyl alcohol, anion-modified polyvinyl alcohol, silanol-modified polyvinyl alcohol, polyvinyl acetal and the like]; cellulose-based resins [methyl cellulose (MC), ethyl cellulose (EC), hydroxyethyl cellulose (HEC), carboxymethyl cellulose (CMC), hydroxypropyl cellulose (HPC), hydroxyethylmethyl cellulose, hydroxypropylmethyl cellulose and the like]; chitins, chitosans, starch; resins having an ether bond [polyethylene oxide (PEO), polypropylene oxide (PPO), polyethylene glycol (PEG), polyvinylether (PVE) and the like]; or, resins having a carbamoyl group [polyacryl amide (PAAM), polyvinyl pyrrolidone (PVP), polyacrylic acid hydrazide, and the like].

Examples of the nonionic surfactants include polyoxyalkylene alkyl ethers and polyoxyalkylene alkylphenyl ethers (for example, diethylene glycol monoethyl ether, diethyleneglycol diethyl ether, polyoxyethylene lauryl ether, polyoxyethylene stearyl ether, polyoxyethylene nonylphenyl ether and the like), oxyethylene-oxypropylene block copolymers and sorbitan fatty acid esters (for example, sorbitan monolaurate, sorbitan monooleate, sorbitan trioleate and the like), polyoxyethylene sorbitan fatty acid esters (for example, polyoxyethylene sorbitan monolaurate, polyoxyethylene sorbitan monoloeate, polyoxyethylene sorbitan triorate and the like), polyoxyethylene sorbitol fatty acid esters (for example, polyoxyethylene sorbit tetraoleate and the like), glycerin fatty acid esters (for example, glycerol monooleate and the like), polyoxyethylene glycerin fatty acid esters (polyoxyethylene glycerin monostearate, polyoxyethylene glycerin monooleate and the like), polyoxyethylene fatty acid esters (polyethylene glycol monolaurate, polyoxyethylene glycol monooleate and the like), polyoxyethylene alkylamines, acetylene glycols (for example, 2,4,7,9-tetramethyl-5-decine-4,7-diol and ethyleneoxide adduct of 2,4,7,9-tetramethyl-5-decine-4,7-diol), and among them, polyoxyalkylene alkyl ethers are preferable.

Examples of the amphoteric surfactants include an amino acid-type, carboxy ammonium betaine-type, sulfone ammonium betaine-type, ammonium sulfuric ester betaine-type and imidazolium betaine type-surfactants, for example, surfactants as recited in the U.S. Pat. No. 3,843,368, JP-A. Nos. 59-49535, 63-236546, 5-303205, 8-262742 and 10-282619 can be preferably used. As the amphoteric surfactant, amino acid-type amphoteric surfactants are preferable, and as the amino acid-type amphoteric surfactants, as recited in JP-A No. 5-303205, surfactants derived from amino acids (glycine, glutamic acid, histidine acid and the like) are exemplified, and more specifically, for example, an N-aminoacylic acid into which a long chain acyl group is introduced, and the salt thereof is exemplified.

As the anionic surfactant, a fatty acid salt (for example, sodium stearate and potassium oleate), an alkyl sulfuric ester salt (for example, sodium lauryl sulfate and triethanolamine lauryl sulfate), a sulfonate (for example, sodium dodecylbenzene sulfonate), an alkyl sufosuccinate (for example, sodium dioctyl sulfosuccinate), an alkyl diphenyl ether disulfonate, an alkyl phosphate, and the like are exemplified.

As the cationic surfactant, an alkylamine salt, a quaternary ammonium salt, a pyridinium salt, an imidazolium salt and the like are exemplified.

As the fluorine-based surfactants, compounds derived from an intermediate having a perfluoroalkyl group with the use of methods such as an electrolytic fluorination, telomerization and oligomerization are exemplified.

For example, a perfluoroalkyl sulfonate, a perfluoroalkyl carboxylate, a perfluoroalkyl ethyleneoxide adduct, a perfluoroalkyl trialkylammonium salt, a perfluoroalkyl group-containing oligomer, a perfluoroalkyl phosphoric ester and the like are exemplified.

As the silicone-based surfactant, a silicone oil modified with an organic group is preferable, and the silicone oil may assume a structure modified with an organic group at the side chain of a siloxane structure, a structure modified with organic groups at the both end terminals, or a structure modified with an organic group at one end terminal. the modification with an organic group includes an amino modification, a polyether modification, an epoxy modification, a carboxyl modification, a carbinol modification, an alkyl modification, an aralkyl modification, a phenol modification and a fuluorine modification.

The content of a water-soluble resin or a surfactant at the time of suspension polymerization of the present invention, is preferably from 0.01% by mass to 10% by mass in an aqueous solution, more preferably from 0.1% by mass to 7% by mass, and still more preferably from 0.5% by mass to 5% by mass is preferable.

The polymer gel after the suspension polymerization reaction may be taken out by filtration or centrifugal separation. After taking out the polymer gel, it is preferable to wash the polymer gel with both of water or a water-soluble solvent such as alcohol, and a hydrophobic solvent such as toluene and ISOPAR M (registered trademark), for the purpose of removing an unreacted monomer component, a polymerization initiator, a water-soluble resin or a surfactant, after taking out the polymer gel.

After washing the swollen gel obtained in the above, the gel may be dried in order to remove residual solvent. The drying temperature is preferably from 50° C. to 200° C., more preferably 60° C. to 180° C., and further more preferably 70° C. to 150° C. In addition, in order shorten drying time, the swollen gel may be dried under reduced pressure.

Further, the surface of the polymer gel particles may be treated with a silane coupling agent for the purpose of improving the dispersibility of polymer gel particles or the fixability to a substrate. The silane coupling agent has preferably an organic functional group (for example, a vinyl group, an amino group (primary to tertiary amino groups and a quaternary ammonium salt group), an epoxy group, a mercapto group, a chloro group, an alkyl group, a phenyl group and an ester group), in addition to the moiety for performing the coupling treatment.

Hereinafter, an example of the scheme of the suspension polymerization method as an example of the method of synthesizing the polymer gel is described. The detailed synthetic method will be described in the examples as explained later.

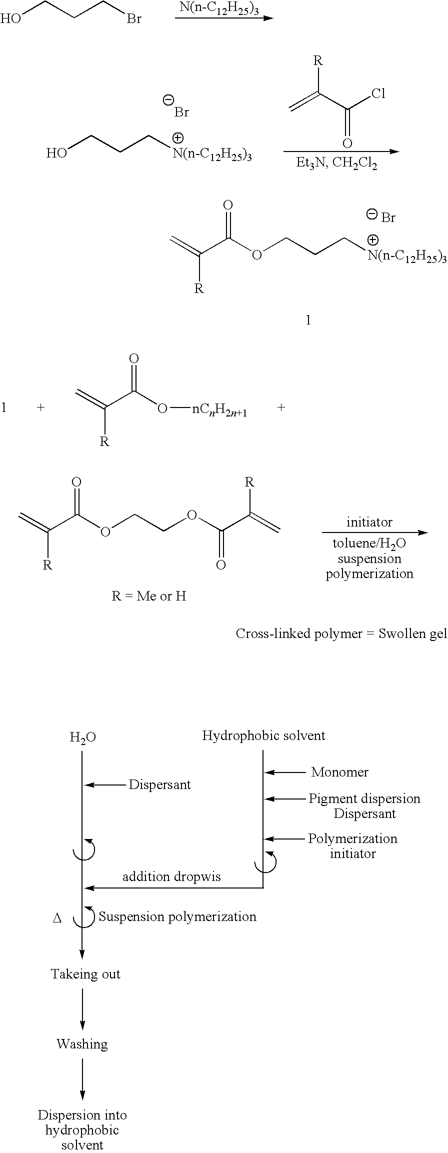

Further, in order to speed up the volumetric change of the ionic polymer gel, it is preferable to make the polymer gel porous so that the penetration and effusion of a liquid are facilitated. The polymer gel can be made porous generally by a method of freeze-drying a pigment-containing swollen polymer gel.

A preferable range of content ratio of the ionic polymer gel and the hydrophobic solvent (ionic polymer gel:hydrophobic solvent) is from 1; 2,000 to 1:1, more preferably from 1:100 to 1:10, by molar ratio in the polymer gel-containing composition of the present invention.

(3) Other Additives

### (1) Coloring Material

Further, dye or pigment may be added to the polymer gel-containing composition of the present invention. The dye or pigment is preferably fixed physically or chemically to the ionic polymer gel.

Preferable examples of dyes include, for example, black nigrosine-based dyes, azo dyes such as red, green, blue, cyan, magenta and yellow color dyes, anthraquinone-based dyes, indigo -based dyes, phthalocyanine-based dyes, carbonium dyes, quinoneimine dyes, methine dyes, quinoline dyes, nitro dyes, benzoquinone dyes, naphthoquinone dyes, naphthalimide dyes and perinone dyes, and dyes having a high light-absorption coefficient are preferable.

Examples of such dyes include, for example, C. I. Direct Yellow 1, 8, 11, 12, 24, 26, 27, 28, 33, 39, 44, 50, 58, 85, 86, 87, 88, 89, 98 and 157; C.I. Acid Yellow 1, 3, 7, 11, 17, 19, 23, 25, 29, 38, 44, 79, 127, 144 and 245; C. I. Basic Yellow 1, 2, 11 and 34; C. I. Food Yellow 4; C. I. Reactive Yellow 37; C. I. Solvent Yellow 6, 9, 17, 31, 35, 100, 102, 103 and 105; C. I. Direct Red 1, 2, 4, 9, 11, 13, 17, 20, 23, 24, 28, 31, 33, 37, 39, 44, 46, 62, 63, 75, 79, 80, 81, 83, 84, 89, 95, 99, 113, 197, 201, 218, 220, 224, 225, 226, 227, 228, 229, 230 and 231; C. I. Acid Red 1, 6, 8, 9, 13, 14, 18, 26, 27, 35, 37,42, 52, 82, 85, 87, 89, 92, 97, 106, 111, 114, 115, 118, 134, 158, 186, 249, 254 and 289; C. I. Basic Red 1, 2, 9, 12, 14, 17, 18 and 37; C. I. Food Red 14; C. I. Reactive Red 23 and 180; C. I. Solvent Red 5, 16, 17, 18, 19, 22, 23, 143, 145, 146, 149, 150, 151, 157 and 158; C. I. Direct Blue 1, 2, 6, 15, 22, 25, 41, 71, 76, 78, 86, 87, 90, 98, 163, 165, 199 and 202; C. I. Acid Blue 1, 7, 9, 22, 23, 25, 29, 40, 41, 43, 45, 78, 80, 82, 92, 93, 127 and 249; C. I. Basic Blue 1, 3, 5, 7, 9, 22, 24, 25, 26, 28 and 29; C. I. Food Blue 2; C. I. Solvent Blue 22, 63, 78, 83-86, 191, 194, 195 and 104; C. I. Direct Black 2, 7, 19, 22, 24, 32, 38, 51, 56, 63, 71, 74, 75, 77, 108, 154, 168 and 171; C. I. Acid Black 1, 2, 7, 24, 26, 29, 31, 44, 48, 50, 52 and 94; C. I. Basic Black 2 and 8; C. I. Food Black 1 and 2; C. I. Reactive Black 31; C. I. Food Violet 2; C. I. Solvent Violet 31, 33 and 37; C. I. Solvent Green 24 and 25; and C. I. Solvent Brown 3 and 9.

These dyes may be used singly, or may be used by mixing thereof for obtaining desired colors.

As the dyes, in order to fix the dyes to the ionic polymer gel, dyes having a structure with a polymerizable group such as an unsaturated double bond group, or so-called reactive dyes capable of reacting with the ionic polymer gel are preferably used.

The concentration of the dye to be contained in the ionic polymer gel is preferably in the range of from 2% by mass to 70% by mass, and particularly preferably from 5% by mass to 50% by mass relative to the polymer gel of a dry state. A polymer gel having a good light modulating action and intensity can be obtained in the range of the dye concentration.

On the other hand, as pigments contained in the polymer gel, inorganic pigments and organic pigments are preferably used.

Preferable examples of pigments include, bronze powder, titanium black, various kinds of carbon blacks (channel black, furnace black and the like) as black pigments; metal oxides such as titanium oxide and silica as white pigments; light-scattering material such as calcium carbonate and metal powder; for example, color pigments such as phthalocyanine-based cyan pigments, benzidine-based yellow pigments, rhodamine-based magenta pigments, or various kinds of pigments and light-scattering materials such as an anthraquinone-based, azo-based, azo metal complex-based, phthalocyanine-based, quinacridone-based, perylene-based, indigo-based, isoindolinone-based, acrylamide-based materials and zinc sulfide.

For example, as yellow pigments, compounds represented by a condensed azo compound, an isoindolinone compound, an anthraquinone compound, an azo metal complex, a methine compound and an allylamide compound are used. More specifically, C. I. Pigment Yellow 12, 13, 14, 15, 17, 62, 74, 83, 93, 94, 95, 109, 110, 111, 128, 129, 147 and 168 are preferably used.

Further, as magenta pigments, a condensed azo compound, a diketo pyrrolo pyrrole compound, an anthraquinone, a quinacridone compound, a basic dye lake compound, a naphthol compound, a benzimidazolone compound, a thioindigo compound, and a perylene compound are used. More specifically, C. I. Pigment Red 2, 3, 5, 6, 7, 23, 48:2, 48:3, 48:4, 57:1, 81:1, 144, 146, 166, 169, 177, 184, 185, 202, 206, 220, 221 and 254 are particularly preferable.

As cyan pigments, a copper phthalocyanine compound and the derivative thereof, an anthraquinone compound, a basic dye lake compound and the like can be used. More specifically, as a pigment, for example, in particular, C. I. Pigment Blue 1, 7, 15, 15:1, 15:2, 15:3, 15:4, 60, 62 and 66 can be preferably used.

As the pigment, pigments having a highighght-absorption coefficient are preferable.

Further, preferable particle size of pigments is from 0.001 μm to 1 μm by the average particle diameter of primary particles. More preferable particle size is from 0.01 μm to 0.5 μm. When the particle diameter in the above range, the pigment remains within the network structure of the polymer gel, so that the pigment is hard to elute, and the color density is not apt to fall easily.

Furthermore, in these pigments, a pigment that has a polar group such as an acid group, a hydroxyl group, an amino group, a thiol group, a halogen atom, a nitro group and a carbonyl group in a molecule, and that has a tendency to from an aggregate when the concentration of coloring material is high in polymer gel, is preferably used.

It is preferable that the pigment is contained in the network of the ionic polymer gel in a dispersed state as homogeneous as possible, and does not elute from the network structure. To this end, it is preferable that a pigment or light-scattering material is physically confined in the network by optimizing the crosslink density of the ionic polymer gel, a pigment or light-scattering material having an electric, ionic and other physical interaction with the ionic polymer gel is used, or, a pigment or light-scattering material with chemically modified surface thereof is used.

More specifically, for example, a pigment or light-scattering material with chemically modified surface thereof, in which an unsaturated group such as a vinyl group, or a group such as an unpair electron (radical) for chemically bonding with the ionic polymer gel is introduced into the pigment or material, or a polymer material is graft-bonded to the pigment or light-scattering material with chemically modified surface thereof, or the surface of the pigment or light-scattering material is covered with a polymer, or the pigment or light-scattering material is encapsulated, may be exemplified.

The amount of pigment to be contained is preferably an amount equivalent to a saturation absorption concentration or higher. Here, the saturation absorption concentration or higher refers to a state, as an index, where in a polymer gel, in a state where when a pigment having a generally high absorption coefficient is used, a polymer gel is contacted, namely, the polymer gel rarely absorb a liquid due to an external stimulus, (or the polymer gel in a dry state), the pigment contained in such an amount or less that an average interval among pigment particles is expressed by;

(½)·λ (1) (λis wavelength of light).

When a polymer gel forms a state where pigment particles are contained with such an interval, light with a wavelength λ cannot enter among the pigment particles, so that the light absorption of the pigment particles changes from an individual particle absorption to a collective absorption, and the light absorption efficiency changes. Thus, the state where pigment particles become a state where the pigment particles exhibit a collective light absorptive property is called a state where a pigment is contained in a saturation absorption concentration or higher.

Further, if the definition of the saturation absorption concentration is described in terms of another characteristic, the pigment has a concentration where a relationship between the concentration of pigment and the optical density (or amount of light absorption) at a certain optical path length greatly deviates from the linear line relationship.

Accordingly, in order to obtain the saturation absorption concentration or higher in the visible light wavelengths, the interval among pigment particles in a polymer gel in a dry state is preferably 0.2 μm or less, because the wavelengths λ of the visible light are in the range of from 400 nm to 800 nm.

Moreover, when the specific gravity of pigment particles is the same as that of polymer gel, and the average particle diameter of pigment particles is 0.1 μm or less, the pigment contained in an amount of about 3% by mass or more in a polymer gel in a dry state is a rough indication for achieving the saturation absorption concentration or higher as a preferable pigment concentration. However, this is only an indication, and the saturation absorption concentration may vary variously with the particle diameter and the absorption coefficient of pigment particles.

In order to achieve the state of such saturation absorption concentration or higher, in general, the concentration of pigment to be contained in an ionic polymer gel is preferably in the range of from 5% by mass to 95% by mass, and more preferably in the range of from 10% by mass to 95% by mass relative to the polymer gel in a dry state, although the concentration depend on the absorption coefficient of the pigment. When the concentration of pigment is in above range, the saturation absorption concentration or higher is achieved, so that the change of the color density varies with the change of volume, and a sufficient contrast can be obtained. Further, the swelling-contraction proceeds with a high responsiveness, and the amount of volume change is hard to fall.

The ionic polymer gel containing pigment therein may be manufactured by crosslinking the polymer after the pigment is dispersed and mixed homogeneously in the polymer prior to crosslinking, or by adding a pigment to a precursor monomer compound for polymer at the time of polymerization. When a pigment is added at the time of polymerization, the pigment having a polymerizable group or an unpair electron (radical) is preferably used to chemically bond to the polymer as described hereinbefore.

Further, pigment is preferably dispersed as homogeneous as possible. In particular, it is preferable that the pigment is dispersed homogeneously with a mechanical kneading method, a agitation method, or with the use of a dispersant.

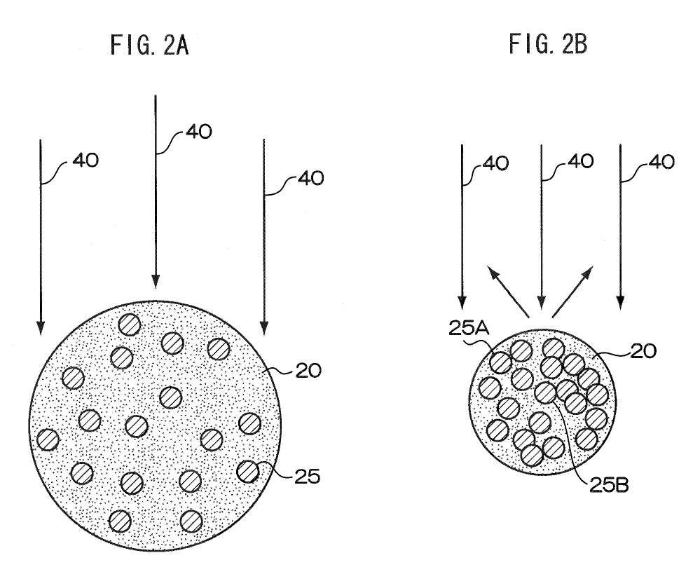

The principle of light modulation of the ionic polymer gel containing a pigment at a concentration of the saturation absorption concentration or higher (hereinafter, may be referred to as “color-forming material”) is explained with reference to FIGS. 2A and 2B.

FIG. 2A is a drawing for illustrating the feature of light modulation by an ionic polymer gel particle in a swollen state. In FIG. 2A, pigment 25 is preferably spread and dispersed homogeneously in a liquid-swollen body of a polymer gel 20 as a constituent material. By dispersing the pigment 25 homogeneously, the pigment 25 absorbs light 40 effectively, so that the light absorption efficiency of the color-forming material becomes higher.

On the other hand, FIG. 2B is a drawing for illustrating the feature of light modulation by an ionic polymer gel particle in a contracted state. As shown in FIG. 2B, the area for absorbing light becomes small due to the contraction of the polymer gel. Further, the pigment density of the pigment 25 becomes higher due to the volumetric contraction of the polymer gel, and aggregation of the pigment is caused. Accordingly, the concentration of the pigment becomes the saturation absorption concentration or higher, resulting in reduction in the light absorption amount per unit amount of pigment. As a result, the light absorption efficiency of the color-forming material is lowered. Namely, it is considered that when aggregates with a certain size or more are formed by aggregation of the pigment, the pigment 25A existing on the surface of the aggregates absorbs light, but the pigment 25B existing within the aggregates does not take part in the light absorption, resulting in reduction in the light absorption amount per unit amount of pigment.

Further, it has been known that when a polymer gel contracts, an uneven structure is formed, and the light-scattering becomes higher as compared with a swollen state. Accordingly, it is considered that the light absorbing performance and the color purity of pigment are lowered due to the light-scattering at the surface of the polymer gel. It is presumed that these actions are compounded, whereby a large difference in light absorbing amounts at the time when the polymer gel is swollen and at the time when the polymer gel is contracted is caused, and that as a result, the color density changes.

That is, the color density can be variously controlled by volumetric change of a material formed of a polymer gel containing pigment. Furthermore, the volume of the color-forming material can be changed stepwise, so that intermediate colors with various optical densities can be expressed.

(2) Other Additives

The polymer gel-containing composition of the present invention may contain ultraviolet absorbers such as a benzophenone-based, a benzotriazle-based and a benzoate-based ultraviolet absorbers; antioxidants such as a phenol-based, an organic sulfur-based, a phosphorus-based and an amine-based antioxidants; optical stabilizers; inorganic pigments such as diatom earth, talc, kaolin, calcined kaolin, heavy calcium carbonate, precipitated calcium carbonate, magnesium carbonate, zinc oxide, aluminum oxide, aluminum hydroxide, magnesium hydroxide, titanium dioxide, barium sulfate, zinc sulfate, amorphous silica, and amorphous calcium silicate and colloidal silica; organic pigments such as a melamine resin filler, a urea-formalin resin filler, polyethylene powder and nylon powder; higher fatty acid metal salts such as, zinc stearate and calcium stearate; higher fatty acid amides such as stearic acidamide; slipping agents such as paraffin, polyethylene wax, polyethylene oxide and caster wax; surfactants containing anionic or nonionic high molecular weight compounds, fluorescent dyes, defoaming agents, and leveling agents.

<Optical Element>

Next, the optical element using the polymer gel-containing composition of the present invention (including the light modulating device of the present invention; hereinafter, referred to as an “optical element of the present invention”) is explained.

The optical element of the present invention is formed by forming the polymer gel-containing composition of the present invention in a layered form on or above a substrate, or sandwiching the polymer gel-containing composition of the present invention in a layered form between a pair of substrates.

The optical element of the present invention is equipped with an electric field applying unit, when the optical element of the present invention is used for a display element, a recording element, an optical modulation element or a light modulating device

As a general electric field applying unit, a pair of electrodes or the like is used. It is preferable that the electrodes are patterned or segmented for arbitrary positions to be light modulated. Further, it is preferable that an ionic gel with specific characteristics is arranged corresponding to the pattern.

In the optical element of the present invention, the ionic polymer gel is preferably fixed to the electrode as described in the above. When two or more electrodes are provided, the ionic polymer gel may be fixed to all the electrodes.

The fixation of the ionic polymer gel can be performed with the use of various bifunctional compounds or adhesives, or by physical means. More specifically, for example, an electrode substrate is beforehand subjected to a treatment with a reactive silane coupling agent to introduce functional groups to the electrode substrate, and the functional groups are allowed to react with functional groups of the ionic polymer gel to form covalent bonds. Additionally, the ionic polymer gel is fixed with the use of various kinds of polyfunctional compounds or adhesives, or the ionic polymer gel is physically fixed onto the sterically-processed surface of the substrate.

In addition, in the fixation of ionic polymer gel, since the responsive property may be lowered when the ionic polymer gel is too closely adhered to the electrode (substrate), it is preferable that the substrate is sterically-processed for forming an convex thereon, and the ionic polymer gel is bonded to the substrate via the convex portions or via a long chain compound.

In the optical element of the present invention, the polymer gel-containing composition of the present invention is preferably sealed to form the light modulating layer. By sealing the light modulating layer, the light modulating layer (polymer gel-containing composition) does not come into contact with ambient air, and degradation of the light modulating layer can be prevented. For example, such structures may be formed by sealing the light modulating layer sandwiched between the electrodes with an adhesive, or by disposing the light modulating layer among the electrodes formed in a cell-like shape.

Various layers may be additionally provided in the optical element of the present invention. For example, a protective layer for the purpose of protecting the optical element, a contamination-preventing layer, an ultraviolet absorbing layer, an antistatic layer, a light reflecting layer, a dielectric layer and a coloring layer such as a color filter may be exemplified.

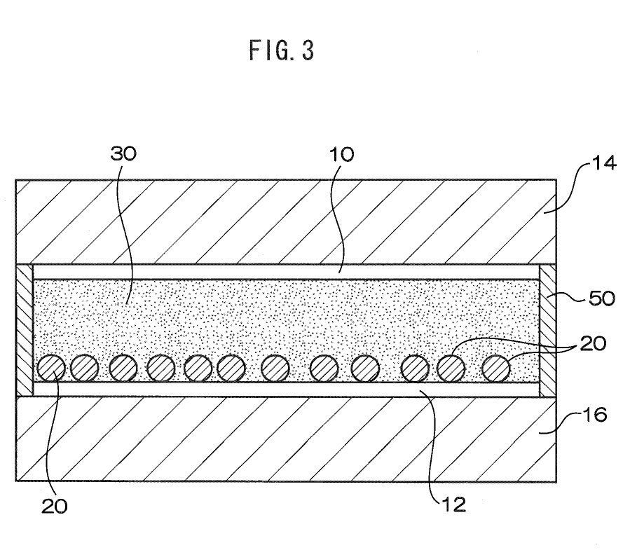

Hereinafter, the constitution of the optical element of the present invention will be described with reference to FIG. 3. In addition, the same notations are given to the members having the same functions through all the drawings, and the explanations thereof are omitted.

FIG. 3 is a schematic configurational drawing showing an example of an optical element of the present invention. The optical element as shown in FIG. 3 has a structure, in which a pair of electrode substrates having electrodes 10 and 12 faces each other on substrates 14 and 16, respectively, ionic polymer gel particles 20 and a hydrophobic solvent 30 are enclosed in the interior (cell) between the electrode substrates. In addition, at least one of the electrode substrates is preferably transparent, and the both electrode substrates are preferably transparent in the case of using the optical element as a light modulating device.

Furthermore, a spacer 50 is formed between a pair of electrode substrates, in order to forming a predetermined interval between the electrode substrates. The ionic polymer gel particles 20 are fixed to the surface of the electrode substrate 12.

As the members of the substrates 14 and 16 of the electrode substrates, a polymer film or tabular substrate such as polyester, polyimide, polymethyl methacrylate, polystyrene, polypropylene, polyethylene, polyamide, nylon, polyvinyl chloride, polyvinylidene chloride, polycarbonate, polyether sulfone, silicone resin, polyacetal resin, fluororesin, cellulose derivative and polyolefin; an inorganic substrate such as a glass substrate, a metal substrate and a ceramic substrate, are preferably used.

Moreover, when using as a transparent optical element such as a light modulating device and the like, a substrate member having a light transmittance of at least 50% or more is preferably used.

As the electrodes 10 and 12, the substrates having a metal oxide layer thereon represented by tin oxide-indium oxide (ITO), tin oxide, zinc oxide and the like are preferably used. The transparent electrodes having a light transmittance of at least 50% or more is preferably used. Further, in the case of the use for a reflection-type optical element, as a electric-current-carrying member provided on the electrode substrate at the farther side from the viewing side, in addition to the metal oxide layer represented by tin oxide-indium oxide (ITO), tin oxide, zinc oxide or the like, a conductive polymer, carbon, a metal layer represented by copper, aluminum, gold, silver, nickel and platinum may be used.

A variety of thicknesses and sizes of the electrode substrate may be used according to a desired optical element (display element), and the thickness and size are not specifically restricted, but preferable thickness ranges from 10 μm to 20 nm. When both the electrode substrate and the electrode are transparent, the electrode substrate and electrode can be used as a transparent-type display element.

An example of a configuration of an ionic polymer gel enclosed between a pair of substrates is shown in FIG. 3, but a plurality of the configurations as shown in FIG. 3 may be laminated. When ionic polymer gels containing pigments (light modulating material) with different colors therein are laminated, the ionic polymer gels can also be used for a laminated color display element.

When using plural colors, it is also possible to form a full color formation or display by placing segments for forming different colors with the use of different combinations of colored polymer gels and pigments on the planar surface of an optical element.

Further, according to the use of an optical element (display element), a wiring, a thin layer transistor, a diode having a metal/insulation layer/metal structure, a variable capacitor, a switching element for driving a ferroelectric substance or the like may be formed on the electrode substrate. In general, in the case of displaying an image in display use, in a constitution having a patterned electrode, a desired pattern is energized, and a volumetric change of an ionic polymer gel is caused on the pattern, so that an image can be displayed. Furthermore, in the case of displaying s color image, the ionic polymer gels with plural different colors are fixed on respective patterns, and a display with color can be realized by turning on electricity to various patterns selectively.

<Use Application>

The polymer gel of the present invention has a large swelling-contracting ratio, and is preferable for the use of a display and light modulation. Accordingly, the polymer gel-containing composition containing the polymer gel can be used preferably for a light modulating element or a filter for controlling the quantity of transmitting light, and further, a display element for displaying an image.

A hydrophobic solvent is used in the polymer gel-containing composition of the present invention. The corrosion of an electrode can be suppressed in the optical element of the present invention using the polymer gel-containing composition, and a stable display and light modulation are possible. Moreover, since the hydrophobic solvent is not electrically energized, the power consumption can be saved and the effective voltage can be raised in the optical element of the present invention. As described hereinbefore, the polymer gel-containing composition of the present invention is preferable for forming an optical element with a large area.

### EXAMPLES

Hereinafter, the present invention will be described with reference to the following examples in detail. Various modifications and changes of materials, reagents, quantity and ratio of materials and mode of operation as described in the examples may be made, without departing from the spirit and scope of the present invention. Accordingly, the present invention is not limited to the examples.

### Synthetic Example 1

### <Synthesis of Monomer>

The following compound-1 was synthesized according to the following scheme:

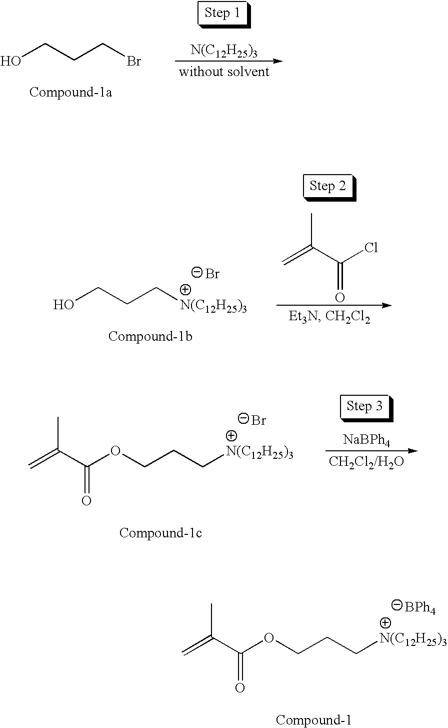

(Step 1)

A mixture of 3-bromo-1-propanol (the above compound-1a) (19.9 g, 143 mmol) and 149 g (286 mmol) of tri-n-dodecylamine was stirred without solvent at 120° C. for 9 hours. After a white solid obtained by being cooled to room temperature was filtered, the white solid was washed with ethyl acetate, and compound-1b was obtained quantitatively.

(Step 2)

The thus obtained compound-1b (31.4 g, 47.5 mmol) and 5.77 g (57.0 mmol) of triethylamine were dissolved in 147 ml of methylene chloride, and 5.46 g (52.2 mmol) of methacryloyl chloride was added thereto dropwise slowly to the reaction solution with ice-cold cooling under nitrogen gas atmosphere. After stirring at room temperature for 2 hours, 200 ml of water was added thereto, and a liquid separatory operation was performed. Thereafter, the solvent was distilled away, and compound-1c was obtained.

(Step 3)

The thus obtained compound-1c (26.9 g, 36.9 mmol) was dissolved in 150 ml of methylene chloride, 28.3 g (82.8 mmol) of sodium tetraphenylborate and 75 ml of water were added thereto, and the resultant two phase system was stirred at room temperature for 7 hours. After 200 ml of water was added to the reaction liquid, a phase separatory operation performed with methylene chloride. The extract was washed with water, and compound-1 was obtained.

### Synthetic Example 2

### <Synthesis of Monomer>

The following compound-2 was synthesized according to the following scheme:

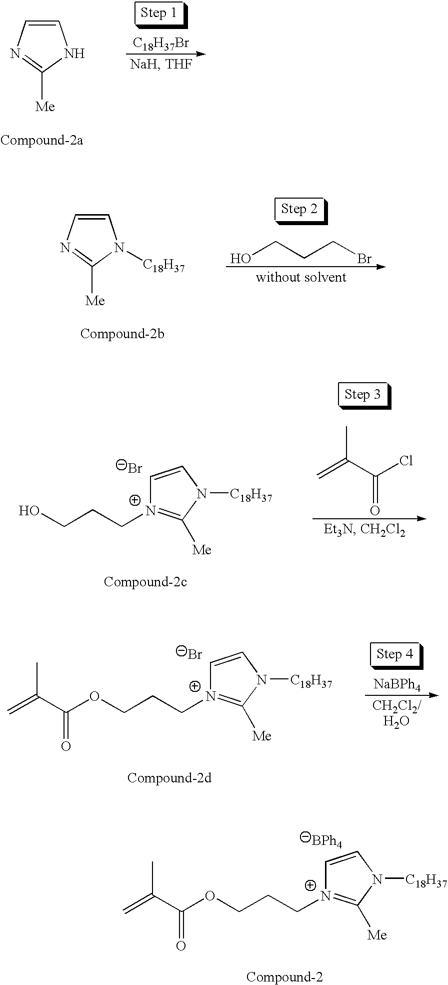

(Step 1)

The above compound-2a (10.0 g, 122 mmol) was dissolved in 240 ml of tetrahydrofuran (THF) solvent, thereafter, 4.87 g (122 mmol) of sodium hydride was slowly added thereto with stirring with ice-cold cooling under nitrogen gas atmosphere, and the mixture was stirred with ice-cold cooling for 30 minutes. After adding 42.6 g (128 mmol) of 1-bromooctadecane thereto at room temperature, the mixture was stirred at 60° C. for 4 hours. After 300 ml of water was added to the reaction solution, an extraction was performed with ethyl acetate, and the extract was washed with an aqueous saturated sodium chloride solution, and was dried with anhydrous magnesium sulfate. After distilling away the solvent, the product was purified with silica gel column chromatography (solvent: hexane/ethyl acetate=10/1), and 40.7 g of compound-2b was obtained.

(Step 2)

The compound-2b (40.1 g, 120 mmol) thus obtained and 16.7 g (120 mmol) of 3-bromo-1-propanol were stirred without solvent at 110° C. for 10 hours. After cooling the reaction solution to room temperature, the obtained wax-like solid was washed with toluene, and purified with silica gel column chromatography, and compound-2c was obtained.

(Step 3)

The obtained compound-2c (36.3 g, 76.6 mmol) and 9.23 g (91.9 mmol) of triethylamine were dissolved in 150 ml of methylene chloride, and 8.41 g (80.5 mmol) of methacryloyl chloride was added dropwise slowly thereto with ice-cold cooling under nitrogen gas atmosphere. After stirring at room temperature for 2 hours, 150 ml of water was added thereto, and a liquid separatory operation was performed. Thereafter, the solvent was distilled away, and compound-2d was obtained.

(Step 4)

The ompound-2d (38.5 g, 71.1 mmol) thus obtained was dissolved in 170 ml of methylene chloride, 31.6 g (92.4 mmol) of sodium tetraphenylborate and 60 ml of water were added thereto, and the resultant two phase system was stirred at room temperature for 9 hours. After 200 ml of water was added to the reaction liquid, a liquid separatory operation performed with methylene chloride. The extract was washed with water, and compound-2 was obtained.

### Example 1

<Preparation of Polymer Gel without Containing Pigment>

A polymer gel particles to be swollen and contracted by applying an electric field were prepared by a normal suspension polymerization method as shown in the following scheme:

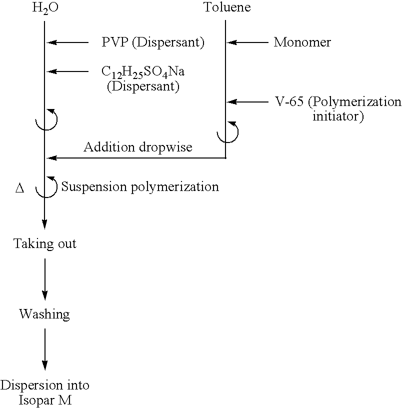

As a monomer, 1.89 g (1.95 mmol) of the compound-1 synthesized in the synthetic example 1, 1.54 g (4.55 mmol) of octadecyl methacrylate, and 12.9 mg (0.065 mmol) of ethyleneglycol dimethacrylate as a cross-linking agent were dissolved in 3 ml of degassed toluene, and the mixture was stirred at room temperature under nitrogen gas atmosphere for 15 minutes. Thereafter, 16.1 mg (0.065 mmol) of V-65 ((trade name) manufactured by Wako Pure Chemical Industries, Ltd.) as a polymerization initiator was added to the reaction solution, and the mixture was stirred at room temperature under nitrogen gas atmosphere for 5 minutes.

Meanwhile, in another vessel different from the reaction liquid, 70 ml of polyvinyl pyrrolidone (PVP) (2% by mass aqueous solution) and 300 mg of sodium dodecyl sulfate were vigorously stirred (600 rpm) at room temperature under nitrogen gas atmosphere, and to the aqueous solution was added dropwise the above toluene solution containing monomers. After stirring for 3 minutes (number of revolutions: 600 rpm) at room temperature, the mixture was stirred at the number of revolutions of 200 rpm at 60° C. for 5 hours.

Subsequently, the reaction liquid was centrifuged with a centrifugal separator to separate into a solution and a solid component, and only a gel-like solid component was taken out. The solid component was washed with water, ethanol and ISOPAR M (refractive index: 1.45) ((registered trademark) manufactured by Exxon Mobil Corporation), and, polymer gel particles were prepared. The refractive index of the obtained polymer gel particles was 1.51.

### Example 2

<Preparation of Polymer Gel without Containing Pigment>

Polymer gel particles containing PEO groups were prepared in a manner similar to Example 1, except that the monomer component was change to the composition as described below. The refractive index of the obtained polymer gel particles was 1.44.

(Monomer Composition)

| | | |
|---|---|---|
| Ethyleneglycol monomethyl ether | 269 mg | (0.975 mmol) |
| monomethacrylate | | |
| (NK Ester M40G (trade name) | | |
| manufactured by Shin-Nakamura | | |
| Chemical Co., Ltd.) | | |
| Compound-2 synthesized in the | 1.89 g | (1.95 mmol) |
| synthesizing example 2 | | |
| Octadecylmethacrylate | 1.21 g | (3.58 mmol) |
| Ethyleneglycol dimethacrylate as a cross- | 12.9 mg | (0.065 mmol) |
| linking agent | | |

### Example 3

### <Preparation of Polymer Gel Particles Containing Pigment>

Polymer gel particles having PEO groups and containing pigment were prepared by a normal suspension polymerization method as shown in the following scheme:

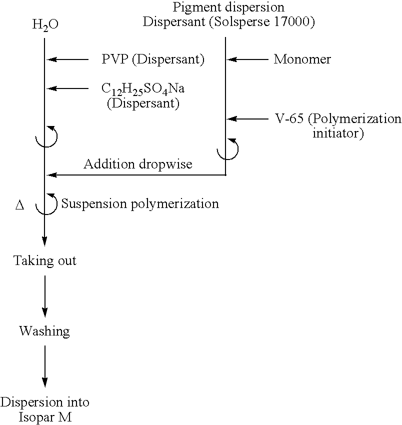

First, a pigment dispersion was prepared prior to the preparation of gel particles by a suspension polymerization method.

A copper phthalocyanine blue pigment (3.0 g) was added to ISOPAR M ((registered trademark) manufactured by Exxon Mobil Corporation) as a solvent, and SOLSPERSE 17000 ((trade name) manufactured by Avecia Inkjet Limited) as a dispersant, and the pigment was dispersed using an ultrasonic homogenizer, and a pigment dispersion containing the pigment in an amount of 10% by mass was prepared.

To 3 ml of the pigment dispersion prepared in the above, were added 1.52 g (1.95 mmol) of the compound-2 synthesized in the above synthesizing example 2, 1.21 g (3.58 mmol) of octadecyl methacrylate as another monomer, 269 mg (0.975 mmol) of ethyleneglycol monomethyl ether monomethacrylate (NK Ester M40G (trade name) manufactured by Shin-Nakamura Chemical Co., Ltd.), and 12.9 mg (0.065 mmol) of ethylene glycol dimethacrylate as a cross-linking agent, and the mixture was stirred at room temperature under nitrogen gas atmosphere for 15 minutes.

Thereafter, 16.1 mg (0.065 mmol) of V-65 as a polymerization initiator was added to the mixture, and the resultant mixture was stirred at room temperature under nitrogen atmosphere for 5 minutes.

Meanwhile, in another vessel different from the reaction liquid, 70 ml of polyvinyl pyrrolidone (PVP) (2% by mass aqueous solution) and 300 mg of sodium dodecyl sulfate were vigorously stirred (600 rpm) under nitrogen gas atmosphere at room temperature, and to the aqueous solution was added dropwise the ISOPAR M solution containing the pigment and monomers. After stirring for 3 minutes (number of revolutions: 600 rpm) at room temperature, the mixture was stirred at the number of revolutions of 200 rpm at 60° C. for 5 hours.

Subsequently, the reaction liquid was centrifuged with a centrifugal separator to separate into a solution and a solid component, and only a gel-like solid component was taken out. The solid component was washed with water, ethanol and ISOPAR M ((registered trademark) manufactured by Exxon Mobil Corporation), and, polymer gel particles containing pigment were prepared.

### Example 4

### (Volumetric Change of Gel Particles by Voltage Drive)

ISOPAR M ((registered trademark) manufactured by Exxon Mobil Corporation), (dielectric constant: 1.9) was added to the polymer gel particles obtained by Example 1 or Example 2, and ISOPAR M dispersion-1 or 2 containing 1% by mass of the polymer gel was prepared.

On a transparent electrode (ITO: tin oxide-indium oxide) substrate with a size of 20 mm×20 mm was prepared a counter substrate equipped with an electrode substrate with the same size as that of the transparent electrode substrate, and a resin spacer having a size of 75 μm (the distance between substrates is 75 μm) was disposed on the surface of the counter electrode inwardly, and the peripheral part between the transparent electrode substrate and the counter electrode was sealed with a heat sensitive adhesive except for an opening for liquid pouring-in portion, and a cell was prepared.

After pouring the ISOPAR M dispersion-1 or 2 into the interior of the cell, the opening was sealed, and elements 1 and 2 for evaluating volumetric change were prepared. The polymer gel was fixed to the electrode by the physical adsorption between the surface of the gel particles and the glass substrate due to the gravitational sedimentation.

When the element-1 and element-2 for evaluation thus obtained were observed under an optical microscope, it was confirmed that the polymer gel particles were arranged in a monolayer form on the electrode substrate.

When the direct-current voltage of 100V was applied between the opposite electrodes in the element-1 and element-2 for evaluation, the volume of the polymer gel particles was changed. When the back substrate (the surface to which the polymer gel particles were adsorbed) was an anode, the polymer gel particles were swollen. On the contrary, when the back substrate was a cathode, the polymer gel particles were contracted.

When the size often polymer gel particle was measured under an optical microscope, the average particle diameter at the time of being swollen was 25 μm, the average particle diameter at the time of being contracted was 20 μm, and the swelling ratio (ratio of area at the time of being swollen/area at the time of being contracted) was 1.56.

In addition, the measurement of the sizes of the swollen gel particles and the contracted gel particles was performed in the state of the gel when a voltage was applied to the gel for 1 minute.

The speed of response of the polymer gel of the element-1 for evaluation was measured, and the value of 100 ms was obtained. The speed of response was visually calculated from the time from the beginning of the voltage application to the completion of the swelling/the contraction, on the bases of slow-motion replay images of a motion picture. The value is an average value of ten reversals of the polarity at 1 Hz of an alternating-current voltage.

Further, when the size often polymer gel particles of the element-2 for evaluation was measured with an electron microscope, the average particle diameter at the time of being swollen was 34 μm, the average particle diameter at the time of being contracted was 22 μm, and the swelling ratio (area ratio) was 2.39.

The speed of response of the polymer gel of the element-2 for evaluation measured according to the above method was 100 ms.

Even when the polymer gel particles of the element-1 and element-2 for evaluation were repeatedly swollen and contracted 10,000 times, the swelling ratios (area ratio) of the element-1 and element-2 were 1.56 and 2.39, respectively.

In addition, in the element-1 and element-2 for evaluation, when voltage was applied, the amount of electric current flowed between the electrodes was 1 μA/cm² or less (below the detection limit).

### Example 5

### (Light Modulating Performance by Voltage Drive)

ISOPAR M ((registered trademark) manufactured by Exxon Mobil Corporation) was added to the polymer gel particles in which the pigment obtained in the Example 3 was dispersed, and an ISOPAR M dispersion-3 containing of 1% by mass of the polymer gel was prepared.

On a transparent electrode (ITO) substrate with a size of 20 mm×20 mm was prepared a counter substrate equipped with an electrode substrate with the same size as that of the transparent electrode substrate, and a resin spacer having a size of 75 μm (the distance between substrates is 75 μm) was disposed on the surface of the counter electrode inwardly, and the peripheral part between the transparent electrode substrate and the counter electrode was sealed with a heat sensitive adhesive except for an opening for liquid pouring-in portion, and a cell was prepared.

After pouring the ISOPAR M dispersion-3 into the interior of the cell, the opening was sealed, and an optical element (light modulating cell)-3 was prepared.

When the optical element-3 thus obtained was observed under an optical microscope, it was confirmed that the polymer gel particles were arranged in a monolayer form on the electrode substrate.

When the direct-current voltage of 75V was applied between the opposite electrodes in the optical element-3, the volume of the polymer gel particles was changed. When the back substrate (the surface to which the polymer gel particles were adsorbed) was an anode, the polymer gel particles were swollen and assumed blue color. On the contrary, when the back substrate was a cathode, the polymer gel particles were contracted, thereby changing to be transparent due to an increase in transmitting light.

When the size of ten polymer gel particle was measured under an optical microscope, the average particle diameter at the time of being swollen was 44 μm, the average particle diameter at the time of being contracted was 21 μm, and the swelling ratio (area ratio) was 4.39.

Even when the polymer gel particles of the optical element-3 were repeatedly swollen and contracted 10,000 times, the swelling ratio (area ratio) of the optical element-3 was 4.39.

Further, the speed of response of the polymer gel of optical element-3 was measured in a manner similar to Example 4, and the value of 100 ms was obtained.

In addition, the amount of electric current flowed between the opposite electrodes was 1 μA/cm² or less (below the detection limit).

The contrast ratio of the contrast of the light modulating element at the time of being swollen (at the time of being colored) of gel particles and at the time of being contracted (at the time of being non-colored) measured with the visible light transmittance of the optical element was 4.0.

The behavior of volumetric change by voltage application was reversible, and even if the polarity of the electrodes was repeatedly reversed (cycle: 1 Hz) 10,000 times, problems such as change in light modulating performance (contrast ratio and speed of response), the coloration of solvent, the corrosion of transparent electrode and the leakage of pigment from the pigment particles were not found.

### Comparative Example 1

Polymer gel particles without containing an ionic group were prepared by the following normal suspension polymerization method.

As a monomer, 3.08 g (9.10 mmol) of octadecyl methacrylate, and 18.1 mg (0.091 mmol) of ethyleneglycol dimethacrylate as a cross-linking agent were dissolved in 3 ml of degassed toluene, and the mixture was stirred at room temperature under nitrogen gas atmosphere for 15 minutes. Thereafter, 22.5 mg (0.091 mmol) of V-65 (trade name) as a polymerization initiator was added to the reaction solution, and the mixture was stirred at room temperature under nitrogen gas atmosphere for 5 minutes.

Meanwhile, in another vessel different from the reaction liquid, 70 ml of polyvinyl pyrrolidone (PVP) (2% by mass aqueous solution) and 300 mg of sodium dodecyl sulfate were vigorously stirred (600 rpm) at room temperature under nitrogen gas atmosphere, and to the aqueous solution was added dropwise the above toluene solution containing monomers. After stirring for 3 minutes (number of revolutions: 600 rpm) at room temperature, the mixture was stirred at the number of revolutions of 200 rpm at 60° C. for 5 hours.

Subsequently, the reaction liquid was centrifuged with a centrifugal separator to separate into a solution and a solid component, and only a gel-like solid component was taken out. The solid component was washed with water, ethanol and ISOPAR M ((registered trademark) manufactured by Exxon Mobil Corporation), and targeted polymer gel particles were prepared.

Using the gel particles thus obtained, a comparative optical element-1 with ISOPAR M as a dispersion solution in accordance with the method recited in Example 4 was prepared. A direct-current voltage of 150 V was applied between the opposite electrodes of the optical element, but change in volume of the polymer gel was not observed.

### Comparative Example 2

Polymer gel particles containing a pigment according to the example 3 of JP-A No. 2003-147221(paragraph numbers [0052] to [0053]) were prepared. Using the polymer gel particles, a comparative optical element-2 containing non-polar ISOPAR M ((registered trademark) manufactured by Exxon Mobil Corp Corporation) as a solvent was prepared in accordance with a method similar to the above Example 5.

A direct-current voltage of 150 V was applied between the opposite electrodes of the obtained comparative optical element-2, but change in volume of the polymer gel was not observed.

As a result, it has become clear that with respect to the electric field drive in a non-polar solvent, the ionic polymer gels obtained according to the present invention exhibited an excellent light modulating performance.

The above results are shown in the following table 1.

TABLE 1

| | | | | | | | | | | Swollen Ratio |
|---|---|---|---|---|---|---|---|---|---|---|
| | | | | Applied | | Speed of | Ratio of | | | after 10,000 |
| | | | | Voltage | Electric Current | Response | Swelling/ | Contrast | Corrosion | Swelling/ |
| | | Pigment | Solvent | (V) | (μA/cm²) | (ms) | Contracting | Ratio | of Electrode | Contracting |
| Example 4 | Element 1 | None | ISOPAR M | 100 | below detection | 100 | 1.56 | — | None | 1.56 |
| | | | | | limit (≦1) | | | | | |
| | Element 2 | None | ISOPAR M | 100 | below detection | 100 | 2.39 | — | None | 2.39 |
| | | | | | limit (≦1) | | | | | |
| Example 5 | Element 3 | Contained | ISOPAR M | 75 | below detection | 100 | 4.39 | 4.0 | None | 4.39 |
| | | | | | limit (≦1) | | | | | |
| Comparative | Comparative | None | ISOPAR M | 150 | below detection | No | 1.00 | — | None | — |
| Example 1 | Element 1 | | | | limit (≦1) | Response | | | | |
| Comparative | Comparative | Contained | ISOPAR M | 150 | below detection | No | 1.00 | — | None | — |
| Example 2 | Element 2 | | | | limit (≦1) | Response | | | | |

In the above table, ISOPAR M is a registered trademark by Exxon Mobil Corporation, and is a hydrophobic solvent in the present invention. ISOPAR M in the following table is also the same.

### Comparative Example 3

Polymer gel particles to be driven in a hydrophilic solvent were prepared in the manner as shown below.

Acrylic acid (16 g) as a monomer and 0.09 g of methylene bisacrylamide as a crosslinking agent ware dissolved in 25 ml of distilled water, and to the mixture was added 8 g of sodium hydroxide for neutralizing acrylic acid, and an aqueous monomer solution was prepared. The aqueous monomer solution was placed in a flask, degassed and purged with nitrogen gas.

To the monomer mixture, was added 0.2 g of ammonium persulfate as a polymerization initiator, and the mixture thus obtained was added to 200 ml of cyclohexane as a dispersion medium, the resultant mixture was placed in a vessel purged with nitrogen gas, and emulsified by agitating at high speed with a homogenizer. Further, 0.1 ml of tetramethyl ethylenediamine as a polymerization promoter was added to the emulsion, and polymerization was performed at 30° C. for 5 hours.

The particles formed by the polymerization were added to a large amount of distilled water, and filtered. This operation was repeated for purification, and polymer gel particles were prepared.

The obtained hydrophilic gel particles were added to dimethyl formamide (DMF, dielectric constant 37) as a hydrophilic dispersing solvent, and a comparative element-3 for evaluation was prepared in a manner similar to the method as recited in the Example 4.

A direct-current voltage of 10 volts was applied between the opposite electrodes of the comparative element-3 for evaluation, thereby changing the volume of the hydrophilic polymer gel particles. When the electrode to which the hydrophilic polymer particles were adsorbed was a cathode, the polymer gel particles were swollen, and on the contrary, when the electrode was an anode, the hydrophilic polymer particles were contracted.

However, in this case, a electric current of 0.19 mA flowed between the opposite electrodes, thereby causing corrosion of the transparent electrode after 1 minute. After the electrode was corroded, swelling and contracting of the hydrophilic gel particles was not observed.

### Example 6

The light modulating elements were prepared in a manner similar to Example 5 except that the polymer gel was changed to the polymer gels as shown in Table 2 below. The light modulating elements were evaluated in a manner similar to that of Example 5. The evaluation results are shown in Table 2.

TABLE 2

| | | | | | | | | | | Swollen |
|---|---|---|---|---|---|---|---|---|---|---|
| | | | | | | | Ratio of | | | Ratio |
| | | | | Applied | | Speed of | Swelling/ | | Corrosion | after 10,000 |
| | Polymer | | | Voltage | Electric Current | Response | Contracting | Contrast | of | Swelling/ |
| | Gel | Pigment | Solvent | (V) | (μA/cm²) | (ms) | (Area Ratio) | Ratio | Electrode | Contracting |
| Element 4 | No. 2 | Contained | ISOPAR M | 110 | below detection limit (≦1) | 100 | 2.19 | 2.0 | None | 2.19 |
| Element 5 | No. 4 | Contained | ISOPAR M | 100 | below detection limit (≦1) | 100 | 3.37 | 3.2 | None | 3.37 |
| Element 6 | No. 7 | Contained | ISOPAR M | 100 | below detection limit (≦1) | 100 | 2.96 | 2.8 | None | 2.96 |
| Element 7 | No. 9 | Contained | ISOPAR M | 100 | below detection limit (≦1) | 100 | 2.88 | 2.8 | None | 2.88 |
| Element 8 | No. 13 | Contained | ISOPAR M | 75 | below detection limit (≦1) | 100 | 4.29 | 4.2 | None | 4.29 |
| Element 9 | No. 15 | Contained | ISOPAR M | 75 | below detection limit (≦1) | 100 | 4.96 | 4.5 | None | 4.96 |
| Element 10 | No. 17 | Contained | ISOPAR M | 75 | below detection limit (≦1) | 100 | 3.66 | 3.4 | None | 3.66 |
| Element 11 | No. 19 | Contained | ISOPAR M | 75 | below detection limit (≦1) | 100 | 3.94 | 3.9 | None | 3.94 |
| Element 12 | No. 22 | Contained | ISOPAR M | 75 | below detection limit (≦1) | 100 | 3.70 | 3.5 | None | 3.70 |
| Element 13 | No. 25 | Contained | ISOPAR M | 100 | below detection limit (≦1) | 100 | 2.35 | 2.1 | None | 2.35 |
| Element 14 | No. 27 | Contained | ISOPAR M | 100 | below detection limit (≦1) | 100 | 2.41 | 2.1 | None | 2.41 |

As shown in Table 2, electric current did not flow in the solvent in the light modulating elements 4 to 14, the corrosion of the electrodes was suppressed, and a high contrast and a high speed of response were achieved. Furthermore, a high swelling ratio was maintained even after swelling and contracting was repeated 10,000 times.

In particular, it is understandable that when an alkyl-substituted imidazolium group as an ionic group, a straight-chained stearyl group as a hydrophobic group, and a tetraethylene glycol monomethyl ether group as a hydrophilic group were introduced to a polymer gel, the polymer gel was particularly excellent in terms of the swelling/contracting ratio (area ratio) and the contrast ratio.

### Example 7

Light modulating elements were prepared in a manner similar to Example 5 except that the solvent was changed to the solvents as shown in Table 3 below. The light modulating elements were evaluated in a manner similar to that of Example 5. The evaluation results are shown in Table 3.

TABLE 3

| | | | | | | | Ratio of | | | Swollen Ratio |
|---|---|---|---|---|---|---|---|---|---|---|
| | | | Solvent | Applied | | Speed of | Swelling/ | | | after 10,000 |
| | Polymer | | (Dielectric | Voltage | Electric Current | Response | Contracting | Contrast | Corrosion | Swelling/ |
| | Gel | Pigment | constant) | (V) | (μA/cm²) | (ms) | (Area Ratio) | Ratio | of Electrode | Contracting |
| Element 3 | No. 14 | Contained | ISOPAR M | 75 | below detection limit | 100 | 4.39 | 4.0 | None | 4.39 |
| | | | (1.9) | | (≦1) | | | | | |
| Element 15 | No. 14 | Contained | Hexane | 75 | below detection limit | 100 | 4.42 | 4.0 | None | 4.42 |
| | | | (1.9) | | (≦1) | | | | | |
| Element 16 | No. 14 | Contained | Toluene | 75 | below detection limit | 100 | 4.55 | 4.1 | None | 4.55 |
| | | | (2.2) | | (≦1) | | | | | |
| Element 17 | No. 14 | Contained | o-Xylene | 75 | below detection limit | 100 | 4.69 | 4.2 | None | 4.69 |
| | | | (2.27) | | (≦1) | | | | | |
| Element 18 | No. 14 | Contained | Chloroform | 75 | below detection limit | 100 | 3.96 | 3.8 | None | 3.29 |
| | | | (4.8) | | (≦1) | | | | | |

As shown in Table 3, the ionic polymer gels are swollen and contracted even when the hydrophobic solvent is changed, the corrosion of the electrode does not arise, and the light modulating is stably repeatable.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. A polymer gel-containing composition comprising a solvent having a dielectric constant of 5 or less at 20° C., and an ionic polymer gel whose volume is changeable due to being driven with voltage.

2. The polymer gel-containing composition according to claim 1, wherein the ionic polymer gel has a hydrophobic group.

3. The polymer gel-containing composition according to claim 2, wherein the hydrophobic group is a straight-chained, branched or cyclic alkyl group having 6 to 50 carbon atoms, or an aromatic group having 5 to 50 carbon atoms.

4. The polymer gel-containing composition according to claim 2, wherein the hydrophobic group is a straight-chained, branched or cyclic alkyl group having 10 to 36 carbon atoms.

5. The polymer gel-containing composition according to claim 1, wherein the ionic polymer gel has an ionic group, and the ionic group is a quaternary ammonium salt group or a heterocyclic group.

6. The polymer gel-containing composition according to claim 5, wherein the ionic group is an ionic group with delocalized charge.

7. The polymer gel-containing composition according to claim 1, wherein the ionic polymer gel contains a hydrophobic group and a ionic group, and the ratio of the hydrophobic group to a ionic group is from 50:50 to 80:20 by molar ratio.

8. The polymer gel-containing composition according to claim 1, wherein the ionic polymer gel contains a hydrophobic group, an ionic group and a hydrophilic group.

9. The polymer gel-containing composition according to claim 8, wherein the hydrophilic group has a polyethyleneoxy group or a polypropyleneoxy group.

10. The polymer gel-containing composition according to claim 8, wherein the ratio of the molar number of the hydrophilic group to the total molar number of the ionic group and the hydrophobic group is from 10:90 to 30:70.

11. The polymer gel-containing composition according to claim 1, wherein the ionic polymer gel includes a polymer compound having a repeating structure represented by the following Formula (1) or (2): 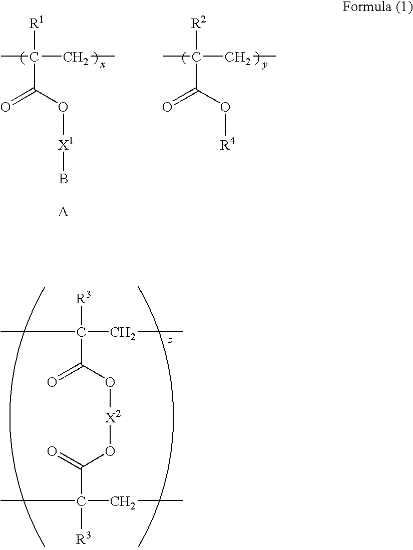
wherein in Formula (1), R¹, R² and R³ each independently represent a hydrogen atom or an alkyl group; R⁴ represents a straight-chained, branched or cyclic alkyl group; X¹ and X² each independently represent a divalent linking group; B represents a cation or an anion; A represents a counter ion therefor; and x, y and z each represent mole %, and satisfy the relationships of 0<x≦90, 0<y≦90, 0<z≦10, and 70≦x+y+z≦100, 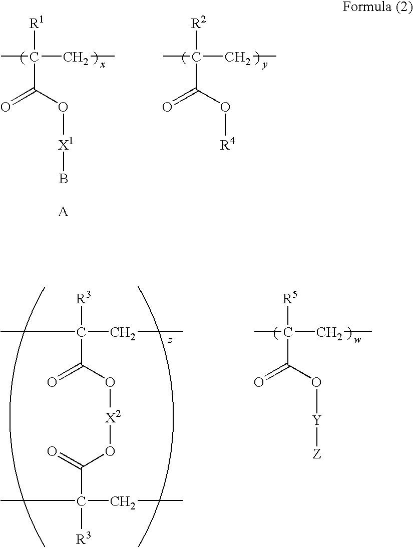
wherein in Formula (2), R¹, R², R³ and R⁵ each independently represent a hydrogen atom or an alkyl group; R⁴ represents a straight-chained, branched or cyclic alkyl group; X¹ and X² each independently represent a divalent linking group; B represents a cation or an anion; A represents a counter ion therefor; Y represents a polyethyleneoxy group or a polypropyleneoxy group; Z represents a straight-chained, branched or cyclic alkyl group or a hydrogen atom; and x, y, z and w each represent mole %, and satisfy the relationships of 0<x≦90, 0<y≦90, 0<z≦10, 0<w<30 and 70≦x+y+z<100.

12. The polymer gel-containing composition according to claim 11, wherein in Formula (1) or (2), x is from 5 mole % to 60 mole %.

13. The polymer gel-containing composition according to claim 11, wherein in Formula (1) or (2), y is from 50 mole % to 90 mole %.

14. The polymer gel-containing composition according to claim 11, wherein in Formula (1) or (2), z is from 0.01 mole % to 3 mole %.

15. The polymer gel-containing composition according to claim 11, wherein in Formula (2), w is from 5 mole % to 30 mole %.

16. The polymer gel-containing composition according to claim 1, further comprising a pigment.

17. A light modulating device comprising:
a pair of electrodes, at least one of which is a transparent electrode; and
a layer containing the polymer gel-containing composition according to claim 1 between the electrodes.

18. A light modulating method using a light modulating device comprising a pair of electrodes, at least one of which is a transparent electrode, and a layer containing the polymer gel-containing composition according to claim 1 between the electrodes, the method comprising applying a voltage to the light modulating device by changing the polarity of the pair of the electrodes alternately.
